(19) United States
(12) Patent Application Publication
(10) Pub. No.: US 2026/0188168 A1
(43) Pub. Date: Jul. 2, 2026

(54) DRIVING CIRCUIT AND DISPLAY SUBSTRATE

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventors: Ran ZHANG, Beijing (CN); Yongxian XIE, Beijing (CN); Xiaoye MA, Beijing (CN); Tong YANG, Beijing (CN); Liping LEI, Beijing (CN); Zhixiang ZOU, Beijing (CN); Yongcan WANG, Beijing (CN); Fengzhen LV, Beijing (CN)

(73) Assignees: HEFEI XINSHENG OPTOELECTRONICS TECHNOLOGY CO., LTD., Hefei, Anhui (CN); BOE TECHNOLOGY GROUP CO., LTD., Beijing (CN)

(21) Appl. No.: 18/852,325

(22) PCT Filed: Apr. 26, 2023
(86) PCT No.: PCT/CN2023/090959

§ 371 Date: Sep. 27, 2024

(51) Int. Cl. G09G 3/20

(52) U.S. Cl. CPC G09G 3/2092; G09G 2310/08; G09G 2330/04

(57) ABSTRACT

A driving circuit includes a driving control signal generation circuit and a multi-channel output circuit; the multi-channel output circuit includes N stage of output sub-circuits; N is an integer greater than 1; the driving control signal generation circuit is configured to generate a driving control signal, and the driving control signal is output through the driving control signal output terminal; an nth output sub-circuit is electrically connected to the driving control signal output terminal, an nth output clock signal line and an nth driving signal output terminal respectively, the nth output sub-circuit is configured to control the nth output clock signal line to provide an nth output clock signal to the nth driving signal output terminal under the control of the driving control signal; n is a positive integer less than or equal to N.

### TECHNICAL FIELD

The present disclosure relates to the field of display technology, in particular to a driving circuit and a display substrate.

### BACKGROUND

In the related art, oxide thin film transistors have high electron mobility and low leakage current characteristics, which can realize the design of high resolution, high refresh rate, low power consumption and low frequency driving of display panels. The related driving circuit using oxide thin film transistors only drives one row of pixel circuits. In order to ensure the normal operation of a display panel including multiple rows of pixel circuits, a large number of transistors are required, which is not conducive to reducing the frame area.

### SUMMARY

In one aspect, the present disclosure provides in some embodiments a driving circuit, including a driving control signal generation circuit and a multi-channel output circuit; wherein the multi-channel output circuit includes N stage of output sub-circuits; N is an integer greater than 1; the driving control signal generation circuit is configured to generate a driving control signal, and the driving control signal is output through a driving control signal output terminal; an nth output sub-circuit is electrically connected to the driving control signal output terminal, an nth output clock signal line and an nth driving signal output terminal respectively, the nth output sub-circuit is configured to control the nth output clock signal line to provide an nth output clock signal to the nth driving signal output terminal under the control of the driving control signal; n is a positive integer less than or equal to N.

Optionally, the nth output sub-circuit includes an nth output transistor; a control electrode of the nth output transistor is electrically connected to the driving control signal output terminal, a first electrode of the nth output transistor is electrically connected to the nth output clock signal line, and a second electrode of the nth output transistor is electrically connected to the nth driving signal output terminal.

Optionally, the nth output sub-circuit further includes an nth on-off control transistor; the control electrode of the nth output transistor is electrically connected to the driving control signal output terminal through the nth on-off control transistor; a control electrode of the nth on-off control transistor is electrically connected to a first voltage line, a first electrode of the nth on-off control transistor is electrically connected to the driving control signal output terminal, and a second electrode of the nth on-off control transistor is electrically connected to the control electrode of the nth output transistor.

Optionally, the nth output sub-circuit further includes an nth output capacitor; a first electrode plate of the nth output capacitor is electrically connected to the control electrode of the nth output transistor, and a second electrode plate of the nth output capacitor is electrically connected to the second electrode of the nth output transistor.

Optionally, the nth output sub-circuit further includes an nth output pull-down unit; the nth output pull-down unit is electrically connected to a pull-down node, the nth driving signal output terminal and a second voltage line respectively, and is configured to control to connect the nth driving signal output terminal and the second voltage line under the control of a potential of the pull-down node.

Optionally, the pull-down node includes a first pull-down node and a second pull-down node; the nth output pull-down unit includes an nth first output pull-down transistor and an nth second output pull-down transistor; a control electrode of the nth first output pull-down transistor is electrically connected to the first pull-down node, and a first electrode of the nth first output pull-down transistor is electrically connected to the nth driving signal output terminal, a second electrode of the nth first output pull-down transistor is electrically connected to the second voltage line; a control electrode of the nth second output pull-down transistor is electrically connected to the second pull-down node, and a first electrode of the nth second output pull-down transistor is electrically connected to the nth driving signal output terminal, a second electrode of the nth second output pull-down transistor is electrically connected to the second voltage line.

Optionally, the driving control signal generation circuit includes a pull-up node control circuit, a first pull-down node control circuit, a second pull-down node control circuit and a driving control output circuit; the pull-up node control circuit is configured to control a potential of the pull-up node; the first pull-down node control circuit is configured to control a potential of the first pull-down node under the control of the potential of the pull-up node; the second pull-down node control circuit is configured to control a potential of the second pull-down node under the control of the potential of the pull-up node; the driving control output circuit is electrically connected to the pull-up node, the first pull-down node, the second pull-down node, the driving control signal output terminal, the driving control clock signal line and the second voltage line, respectively, is configured to control to connect the driving control clock signal line and the driving control signal output terminal under the control of the potential of the pull-up node, and control to connect the driving control signal output terminal and the second voltage line under the control of the potential of the first pull-down node, and control to connect the driving control signal output terminal and the second voltage line under the control of the potential of the second pull-down node.

Optionally, the driving control signal generation circuit further includes a carry output circuit; the carry output circuit is electrically connected to the pull-up node, the first pull-down node, the second pull-down node, a carry output terminal, the driving control clock signal line and a third voltage line respectively, and is configured to control to connect the driving control clock signal line and the carry output terminal under the control of the potential of the pull-up node, and control to connect the carry output terminal and the third voltage line under the control of the potential of the first pull-down node, and control to connect the carry output terminal and the third voltage line under the control of the potential of the second pull-down node.

Optionally, the pull-up node control circuit is electrically connected to an input terminal, a frame reset line, the first pull-down node, the second pull-down node, a first reset terminal, the pull-up node and the third voltage line respectively, is configured to control the potential of the pull-up node under the control of an input signal provided by the input terminal, and control to connect the pull-up node and the third voltage line under the control of a frame reset signal provided by the frame reset line, control to connect the pull-up node and the third voltage line under the control of the potential of the first pull-down node, and control to connect the pull-up node and the third voltage line under the control of the potential of the second pull-down node, and control to connect the pull-up node and the third voltage line under the control of a first reset signal provided by the first reset terminal; the first pull-down node control circuit is electrically connected to a first control voltage line, the first pull-down node, the pull-up node and the third voltage line respectively, and is configured to control the potential of the first pull-down node under the control of a first control voltage provided by the first control voltage line and the potential of the pull-up node; the second pull-down node control circuit is electrically connected to a second control voltage line, the second pull-down node, the pull-up node and the third voltage line respectively, and is configured to control the potential of the second pull-down node under the control of a second control voltage provided by the second control voltage line and the potential of the pull-up node; the driving control output circuit is also electrically connected to a second reset terminal, and is configured to control to connect the driving control signal output terminal and the second voltage line under the control of a second reset signal provided by the second reset terminal.

Optionally, the pull-up node control circuit includes a first transistor, a second transistor, a third transistor, a fourth transistor and a fifth transistor; a control electrode of the first transistor is electrically connected to a first electrode of the first transistor and the input terminal, and a second electrode of the first transistor is electrically connected to the pull-up node; a control electrode of the second transistor is electrically connected to the first reset terminal, a first electrode of the second transistor is electrically connected to the pull-up node, and a second electrode of the second transistor is electrically connected to the third voltage line; a control electrode of the third transistor is electrically connected to the frame reset terminal, a first electrode of the third transistor is electrically connected to the pull-up node, and a second electrode of the third transistor is electrically connected to the third voltage line; a control electrode of the fourth transistor is electrically connected to the first pull-down node, a first electrode of the fourth transistor is electrically connected to the pull-up node, and a second electrode of the fourth transistor is electrically connected to the third voltage line; a control electrode of the fifth transistor is electrically connected to the second pull-down node, a first electrode of the fifth transistor is electrically connected to the pull-up node, and a second electrode of the fifth transistor is electrically connected to the third voltage line; the first pull-down node control circuit includes a sixth transistor and a seventh transistor; a control electrode of the sixth transistor and a first electrode of the sixth transistor are electrically connected to the first control voltage line, and a second electrode of the sixth transistor is electrically connected to the first pull-down node; a control electrode of the seventh transistor is electrically connected to the pull-up node, a first electrode of the seventh transistor is electrically connected to the first pull-down node, and a second electrode of the seventh transistor is electrically connected to the third voltage line; the second pull-down node control circuit includes an eighth transistor and a ninth transistor; a control electrode of the eighth transistor and a first electrode of the eighth transistor are electrically connected to the second control voltage line, and a second electrode of the eighth transistor is electrically connected to the second pull-down node; a control electrode of the ninth transistor is electrically connected to the pull-up node, a first electrode of the ninth transistor is electrically connected to the second pull-down node, and a second electrode of the ninth transistor is electrically connected to the third voltage line.

Optionally, a ratio between a channel width to length ratio of the seventh transistor and a channel width to length ratio of the sixth transistor is greater than or equal to 6, and a ratio between a channel width to length of the ninth transistor and a channel width to length ratio of the eighth transistor is greater than or equal to 6.

Optionally, the first pull-down node control circuit further includes a tenth transistor, and the second pull-down node control circuit further includes an eleventh transistor; a control electrode of the tenth transistor is electrically connected to the input terminal, a first electrode of the tenth transistor is electrically connected to the first pull-down node, and a second electrode of the tenth transistor is electrically connected to the third voltage line; a control electrode of the eleventh transistor is electrically connected to the input terminal, a first electrode of the eleventh transistor is electrically connected to the second pull-down node, and a second electrode of the eleventh transistor is electrically connected to the third voltage line.

Optionally, the carry output circuit includes a twelfth transistor, a thirteenth transistor and a fourteenth transistor; a control electrode of the twelfth transistor is electrically connected to the pull-up node, a first electrode of the twelfth transistor is electrically connected to the driving control clock signal line, and a second electrode of the twelfth transistor is electrically connected to the carry output terminal; a control electrode of the thirteenth transistor is electrically connected to the first pull-down node, a first electrode of the thirteenth transistor is electrically connected to the carry output terminal, and a second electrode of the thirteenth transistor is electrically connected to the third voltage line; a control electrode of the fourteenth transistor is electrically connected to the second pull-down node, a first electrode of the fourteenth transistor is electrically connected to the carry output terminal, and a second electrode of the fourteenth transistor is electrically connected to the third voltage line; the driving control output circuit includes a fifteenth transistor, a sixteenth transistor, a seventeenth transistor, an eighteenth transistor and a first capacitor; a control electrode of the fifteenth transistor is electrically connected to the pull-up node, a first electrode of the fifteenth transistor is electrically connected to the driving control clock signal line, and a second electrode of the fifteenth transistor is electrically connected to the driving control signal output terminal; a control electrode of the sixteenth transistor is electrically connected to the first pull-down node, a first electrode of the sixteenth transistor is electrically connected to the driving control signal output terminal, and a second electrode of the sixteenth transistor is electrically connected to the second voltage line; a control electrode of the seventeenth transistor is electrically connected to the second pull-down node, a first electrode of the seventeenth transistor is electrically connected to the driving control signal output terminal, and a second electrode of the seventeenth transistor is electrically connected to the second voltage line; a control electrode of the eighteenth transistor is electrically connected to the second reset terminal, a first electrode of the eighteenth transistor is electrically connected to the driving control signal output terminal, and a second electrode of the eighteenth transistor is electrically connected to the second voltage line; a first electrode plate of the first capacitor is electrically connected to the pull-up node, and a second electrode plate of the first capacitor is electrically connected to the driving control signal output terminal.

In a second aspect, an embodiment of the present disclosure provides a display substrate, including a base substrate and a plurality of stages driving circuits arranged on the base substrate.

Optionally, the display substrate includes a peripheral area and a display area; the driving circuit includes a driving control signal generation circuit and a multi-channel output circuit; the multi-channel output circuit and the driving control signal generation circuit are arranged in the peripheral area; the multi-channel output circuit is arranged on a side of the driving control signal generation circuit close to the display area.

Optionally, the multi-channel output circuits include N output sub-circuits and N output clock signal lines; N is an integer greater than 1; the output clock signal line is arranged on a side of the output sub-circuit close to the display area, and the output clock signal line extends along a first direction.

Optionally, the nth output sub-circuit includes an nth output transistor, and the nth output transistor is arranged between the driving control signal generation circuit and the display area; n is a positive integer less than or equal to N.

Optionally, the nth output sub-circuit includes an nth output transistor; n is a positive integer less than or equal to N; an active layer pattern of the nth output transistor includes at least one mutually independent active portion; the active portion extends along the first direction.

Optionally, active layer patterns of output transistors respectively included in the N output sub-circuits are arranged along the first direction.

Optionally, the nth output sub-circuit further includes an nth output pull-down unit, and the nth output pull-down unit includes an nth first output pull-down transistor and an nth second output pull-down transistor; an active layer pattern of the nth first output pull-down transistor and an active layer pattern of the nth second output pull-down transistor are arranged along the first direction; the active layer pattern of the nth first output pull-down transistor and the active layer pattern of the nth second output pull-down transistor both extend along the first direction.

Optionally, the output pull-down units respectively included in the N output sub-circuits are arranged along the first direction.

Optionally, the display substrate includes a peripheral area and a display area; the driving circuit includes a driving control signal generation circuit and a multi-channel output circuit; the driving control signal generation circuit is arranged in the peripheral area; the multi-channel output circuit includes N output sub-circuits, and the nth output sub-circuit includes an nth output transistor; N is an integer greater than 1, and n is a positive integer less than or equal to N; the nth output transistor is arranged in the display area.

Optionally, the display substrate further includes a plurality of gate lines and a plurality of common electrode lines arranged in the display area; the gate line and the common electrode line extend along a second direction; the nth output transistor is arranged between the gate line and the common electrode line.

Optionally, the multi-channel output circuit further includes N output clock signal lines; the output clock signal lines are arranged in the display area.

Optionally, the driving circuit includes a driving control signal generation circuit; the driving control signal generation circuit includes a first transistor, a fourth transistor, a fifth transistor, a tenth transistor, a twelve transistor and a fifteenth transistor; a length to width ratio of an active layer pattern of the first transistor is greater than or equal to 80 and less than or equal to 130; a length to width ratio of an active layer pattern of the fourth transistor and a length to width ratio of an active layer pattern of the fifth transistor are greater than and equal to 18 and less than or equal to 32; a length to width ratio of an active layer pattern of the tenth transistor is greater than or equal to 5 and less than or equal to 10; a length to width ratio of an active layer pattern of the twelfth transistor is greater than or equal to 25 and less than or equal to 50; a length to width ratio of an active layer pattern of the fifteenth transistor is greater than or equal to 16 and less than or equal to 40; the length to width ratio is a ratio between the length of the active layer pattern along the first direction and the width of the active layer pattern along the second direction.

Optionally, the driving circuit includes a driving control signal generating circuit; the driving control signal generating circuit includes a first capacitor; an electrode plate of the first capacitor includes a first electrode plate portion and a second electrode plate portion that are connected to each other; the first electrode plate portion is in the shape of a block; the second electrode plate portion extends along the first direction; a ratio of the length of the second electrode plate portion along the first direction to the width of the second electrode plate portion along the second direction is greater than or equal to 6 and less than or equal to 25.

Optionally, the driving circuit includes a driving control signal generation circuit and a multi-channel output circuit; the driving control signal generation circuit includes a first capacitor and a fifteenth transistor; the multi-channel output circuit includes an output sub-circuit; the output sub-circuit includes an on-off control transistor; the first capacitor is arranged between the fifteenth transistor and the on-off control transistor.

Optionally, the nth output sub-circuit further includes an nth on-off control transistor and an nth output capacitor; the nth on-off control transistor and the nth output capacitor are both arranged in the peripheral area; an active layer pattern of the nth on-off control transistor extends along the first direction; active layer patterns of on-off control transistors respectively included in the N output sub-circuits are arranged along the first direction; output capacitors respectively included in the N output sub-circuits are arranged along the first direction.

Optionally, the display substrate includes a plurality of signal lines, and the signal lines are electrically connected to the driving control signal generation circuit included in the driving circuit, the signal line extends along the first direction; a shortest distance along the second direction between a gate electrode of a transistor included in the driving control signal generation circuit and a signal line closest to the transistor in the driving control signal generation circuit is greater than a first predetermined distance; the first direction intersects the second direction; the gate electrode of the transistor and the signal line are located on a same layer.

Optionally, active layer patterns of transistors in the driving control signal generation circuit included in the driving circuit all extend along the first direction.

Optionally, the active layer pattern of at least one transistor included in the driving circuit includes at least two active pattern portions extending along the first direction; a distance in the second direction between two adjacent active pattern portions in the first direction is greater than a second predetermined distance.

### BRIEF DESCRIPTION OF THE DRAWINGS

FIG. 1 is a structural diagram of a driving circuit according to at least one embodiment of the present disclosure;

FIG. 2 is a circuit diagram of the first output sub-circuit according to at least one embodiment of the present disclosure;

FIG. 3 is a structural diagram of a driving circuit according to at least one embodiment of the present disclosure;

FIG. 4 is a circuit diagram of a driving circuit according to at least one embodiment of the present disclosure;

FIG. 5 is a timing diagram of the driving circuit shown in FIG. 4;

FIG. 6 is a timing diagram of the driving control signal provided by G01, the potential of PM1 and the first driving signal output by GO1 when the driving circuit shown in FIG. 4 is working;

FIG. 7 is a timing diagram of the driving control signal provided by G01, the potential of PM1 and the first driving signal output by GO1 when the driving circuit shown in FIG. 4 is not provided with each on-off control transistor;

FIG. 8 is a circuit diagram of a driving circuit according to at least one embodiment of the present disclosure;

FIG. 9 is a timing diagram of the driving circuit shown in FIG. 8;

FIG. 10 is a top plan view of the driving circuit shown in FIG. 8 according to at least one embodiment of the present disclosure;

FIG. 11A is a top plan view of the gate metal layer in FIG. 10;

FIG. 11B is a top plan view of the gate metal layer in FIG. 10;

FIG. 11C is a top plan view of the gate metal layer in FIG. 10;

FIG. 12A is a top plan view of the semiconductor layer in FIG. 10;

FIG. 12B is a top plan view of the semiconductor layer in FIG. 10;

FIG. 13 is a top plan view of the source-drain metal layer in FIG. 10;

FIG. 14 is a top plan view of the second ITO (indium tin oxide) layer in FIG. 10;

FIG. 15 is a circuit diagram of each output sub-circuit according to at least one embodiment of the present disclosure;

FIG. 16 is the waveform of each driving signal output by the driving circuit in the initial state when each output pull-down transistor is removed;

FIG. 17 is the waveform of each driving signal output by the driving circuit when removing each output pull-down transistor after being at 60 degrees Celsius for 1000 hours;

FIG. 18 is a circuit diagram of a driving circuit according to at least one embodiment of the present disclosure;

FIG. 19 is a top plan view of parts other than MO1, MO2, MO3, and MO4 in the driving circuit shown in FIG. 18;

FIG. 20A is a top plan view of the gate metal layer in FIG. 19;

FIG. 20B is a top plan view of the gate metal layer in FIG. 19;

FIG. 21 is a top plan view of the semiconductor layer in FIG. 19;

FIG. 22 is a top plan view of the source-drain metal layer in FIG. 19;

FIG. 23 is a top plan view of the second ITO (indium tin oxide) layer in FIG. 19;

FIG. 24 is a top plan view of the first output transistor provided in the display area;

FIG. 25 is a top plan view of the gate metal layer in FIG. 24;

FIG. 26 is a top plan view of the semiconductor layer in FIG. 24;

FIG. 27 is a top plan view of the source-drain metal layer in FIG. 24;

FIG. 28 is a top plan view of the first ITO layer in FIG. 24;

FIG. 29 is a top plan view of the second ITO layer in FIG. 24;

FIG. 30 is a structural diagram of a display substrate according to at least one embodiment of the present disclosure;

FIG. 31 is a schematic diagram of the active layer pattern according to at least one transistor in the driving circuit;

FIG. 32 is a schematic diagram of the active layer pattern according to at least one transistor in the driving circuit;

FIG. 33 is a circuit diagram of a driving circuit according to at least one embodiment of the present disclosure;

FIG. 34 is a timing diagram of the driving circuit shown in FIG. 33 in an initial state without going through a reliability test.

FIG. 35 is a timing diagram of the driving circuit shown in FIG. 33 after a reliability test (reliability test for 1000 hours at 60 degrees Celsius).

FIG. 36 is a circuit diagram of a driving circuit according to at least one embodiment of the present disclosure;

FIG. 37 is a circuit diagram of a driving circuit according to at least one embodiment of the present disclosure;

FIG. 38 is a circuit diagram of a driving circuit according to at least one embodiment of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those of ordinary skill in the art without making creative efforts fall within the scope of protection of the present disclosure.

The transistors used in all embodiments of the present disclosure may be transistors, thin film transistors, field effect transistors, or other devices with the same characteristics. In the embodiment of the present disclosure, in order to distinguish the two electrodes of the transistor except the control electrode, one electrode is called the first electrode and the other electrode is called the second electrode.

In actual operation, when the transistor is a triode, the control electrode may be a base electrode, the first electrode may be a collector, and the second electrode may be an emitter; or, the control electrode may be a base electrode, the first electrode may be an emitter, and the second electrode may be a collector.

In actual operation, when the transistor is a thin film transistor or a field effect transistor, the control electrode may be a gate electrode, the first electrode may be a drain electrode, and the second electrode may be a source electrode; or, the control electrode may be a gate electrode, the first electrode may be a source electrode, and the second electrode may be a drain electrode.

The driving circuit described in the embodiment of the present disclosure includes a driving control signal generation circuit and a multi-channel output circuit; the multi-channel output circuit includes N stages of output sub-circuits; N is an integer greater than 1;

The driving control signal generation circuit is configured to generate a driving control signal, and the driving control signal is output through the driving control signal output terminal;

The nth output sub-circuit is electrically connected to the driving control signal output terminal, the nth output clock signal line and the nth driving signal output terminal respectively. The nth output sub-circuit is configured to control the nth output clock signal line to provide the nth output clock signal to the nth driving signal output terminal under the control of the driving control signal; n is a positive integer less than or equal to N.

In related driving circuits, one driving circuit usually drives one row of gate line. In order to ensure that a driving circuit works normally, a lot of transistors are needed, and the transistors need to occupy the frame area. With the development of display products, the market requires narrower frames. In the related art, the data voltage output terminals of ICs (integrated circuits) are mostly multiplexed through multiplexing circuits to provide data voltages for multiple data lines respectively, so as to reduce the number of data voltage output terminals of the ICs. Since driving control is currently mainly performed through Gate On Array (GOA, array substrate row driving) circuits, the driving architecture has become complex, and the design difficulty of a multiplexed gate driving architecture is high. In order to further achieve narrow frame and reduce costs, when the driving circuit described in the embodiment of the present disclosure is working, the driving control signal generating circuit outputs a driving control signal, and the N stages of output sub-circuits outputs N stages of driving signal respectively under the control of the driving control signal, so as to realize the purpose of driving multiple rows of gate lines with one driving circuit, effectively reducing the number of transistors used in the driving circuit and facilitating the realization of narrow frames.

In at least one embodiment of the present disclosure, N equals to 4 as an example.

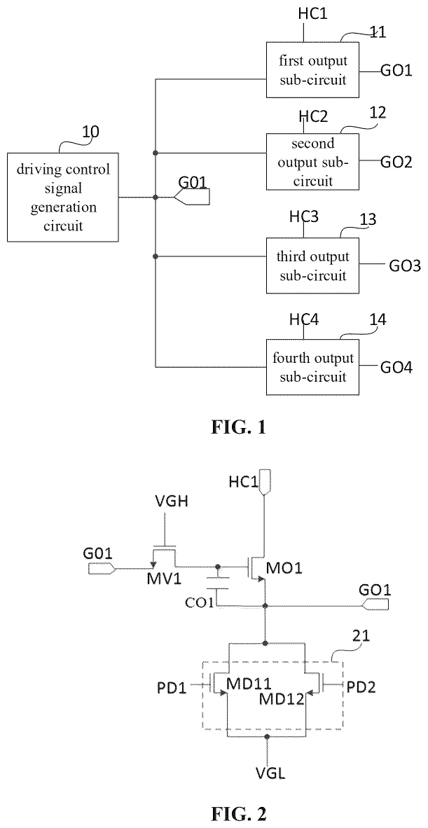

As shown in FIG. 1, the driving circuit according to at least one embodiment of the present disclosure includes a driving control signal generation circuit 10, a first output sub-circuit 11, a second output sub-circuit 12, a third output sub-circuit 13 and a fourth output sub-circuit 14;

The driving control signal generation circuit 10 includes a driving control signal output terminal G01;

The driving control signal generation circuit 10 is configured to generate and output a driving control signal through the driving control signal output terminal G01;

The first output sub-circuit 11 is electrically connected to the driving control signal output terminal G01, the first output clock signal line HC1 and the first driving signal output terminal GO1 respectively, and is configured to control the first output clock signal line HC1 to provide a first output clock signal to the first driving signal output terminal GO1 under the control of the driving control signal;

The second output sub-circuit 12 is electrically connected to the driving control signal output terminal G01, the second output clock signal line HC2 and the second driving signal output terminal GO2 respectively, and is configured to control the second output clock signal line HC2 to provide a second output clock signal to the second driving signal output terminal GO2 under the control of the driving control signal;

The third output sub-circuit 13 is electrically connected to the driving control signal output terminal G01, the third output clock signal line HC3 and the third driving signal output terminal GO3 respectively, and is configured to control the third output clock signal line HC3 to provide a third output clock signal to the third driving signal output terminal GO3 under the control of the driving control signal;

The fourth output sub-circuit 14 is electrically connected to the driving control signal output terminal G01, the fourth output clock signal line HC4 and the fourth driving signal output terminal GO4 respectively, and is configured to control the fourth output clock signal line HC4 to provide a fourth output clock signal to the fourth driving signal output terminal GO4 under the control of the driving control signal.

Optionally, the nth output sub-circuit includes an nth output transistor;
a control electrode of the nth output transistor is electrically connected to the driving control signal output terminal, a first electrode of the nth output transistor is electrically connected to the nth output clock signal line, and a second electrode of the nth output transistor is electrically connected to the nth driving signal output terminal.

Optionally, the nth output sub-circuit further includes an nth on-off control transistor; the control electrode of the nth output transistor is electrically connected to the driving control signal output terminal through the nth on-off control transistor;
A control electrode of the nth on-off control transistor is electrically connected to the first voltage line, a first electrode of the nth on-off control transistor is electrically connected to the driving control signal output terminal, and a second electrode of the nth on-off control transistor is electrically connected to the control electrode of the nth output transistor.

Optionally, the nth output sub-circuit also includes an nth output capacitor;
A first electrode plate of the nth output capacitor is electrically connected to the control electrode of the nth output transistor, and a second electrode plate of the nth output capacitor is electrically connected to the second electrode of the nth output transistor.

In at least one embodiment of the present disclosure, the nth output sub-circuit further includes an nth output pull-down unit;
The nth output pull-down unit is electrically connected to the pull-down node, the nth driving signal output terminal and the second voltage line respectively, and is configured to control to connect the nth driving signal output terminal and the second voltage line under the control of the potential of the pull-down node.

In specific implementation, the nth output sub-circuit may further include an nth output pull-down unit. The nth output pull-down unit controls to connect the nth driving signal output terminal and the second signal line under the control of the pull-down node.

Optionally, the pull-down node may include a first pull-down node and a second pull-down node; the nth output pull-down unit includes an nth first output pull-down transistor and an nth second output pull-down transistor;
A control electrode of the nth first output pull-down transistor is electrically connected to the first pull-down node, and a first electrode of the nth first output pull-down transistor is electrically connected to the nth driving signal output terminal, a second electrode of the nth first output pull-down transistor is electrically connected to the second voltage line;
A control electrode of the nth second output pull-down transistor is electrically connected to the second pull-down node, and a first electrode of the nth second output pull-down transistor is electrically connected to the nth driving signal output terminal, a second electrode of the nth second output pull-down transistor is electrically connected to the second voltage line.

In at least one embodiment of the present disclosure, the first voltage line may be a high voltage line, and the second voltage line may be a first low voltage line, but is not limited thereto.

As shown in FIG. 2, at least one embodiment of the first output sub-circuit may include a first output transistor MO1, a first on-off control transistor MV1, a first output capacitor CO1 and a first output pull-down unit 21; the pull-down node may include a first pull-down node PD1 and a second pull-down node PD2; the first output pull-down unit 21 includes a first first output pull-down transistor MD11 and a first second output pull-down transistor MD12;
The drain electrode of the first output transistor MO1 is electrically connected to the first output clock signal line HC1, and the source electrode of the first output transistor MO1 is electrically connected to the first driving signal output terminal GO1;
The gate electrode of the first output transistor MO1 is electrically connected to the driving control signal output terminal G01 through the first on-off control transistor MV1;
The gate electrode of the first on-off control transistor MV1 is electrically connected to the high voltage line VGH, and the drain electrode of the first on-off control transistor MV1 is electrically connected to the driving control signal output terminal G01, the source electrode of the first on-off control transistor MV1 is electrically connected to the gate electrode of the first output transistor MO1;
The first electrode plate of the first output capacitor CO1 is electrically connected to the gate electrode of the first output transistor MO1, and the second electrode plate of the first output capacitor CO1 is electrically connected to the source electrode of the first output transistor MO1;
The gate electrode of the first first output pull-down transistor MD11 is electrically connected to the first pull-down node PD1, and the drain electrode of the first first output pull-down transistor MD11 is connected to the first driving signal output terminal GO1, the source electrode of the first first output pull-down transistor MD11 is electrically connected to the first low voltage line VGL;
The gate electrode of the first second output pull-down transistor MD12 is electrically connected to the second pull-down node PD2, and the drain electrode of the first second output pull-down transistor MD12 is electrically connected to the first driving signal output terminal GO1, the source electrode of the first second output pull-down transistor MD12 is electrically connected to the first low voltage line VGL.

In at least one embodiment shown in FIG. 2, all transistors are n-type transistors, and all transistors are oxide thin film transistors, but this is not a limitation.

In at least one embodiment of the present disclosure, the driving control signal generation circuit includes a pull-up node control circuit, a first pull-down node control circuit, a second pull-down node control circuit and a driving control output circuit;
The pull-up node control circuit is configured to control the potential of the pull-up node;
The first pull-down node control circuit is configured to control the potential of the first pull-down node under the control of the potential of the pull-up node;
The second pull-down node control circuit is configured to control the potential of the second pull-down node under the control of the potential of the pull-up node;
The driving control output circuit is electrically connected to the pull-up node, the first pull-down node, the second pull-down node, the driving control signal output terminal, the driving control clock signal line and the second voltage line, respectively, is configured to control to connect the driving control clock signal line and the driving control signal output terminal under the control of the potential of the pull-up node, and control to connect the driving control signal output terminal and the second voltage line under the control of the potential of the first pull-down node, and control to connect the driving control signal output terminal and connected to the second voltage line under the control of the potential of the second pull-down node.

In specific implementation, the driving control clock signal line is configured to provide a driving control clock signal.

In specific implementation, the driving control signal generation circuit may include a pull-up node control circuit, a first pull-down node control circuit, a second pull-down node control circuit and a driving control output circuit. The pull-up node control circuit controls the potential of the pull-up node. The first pull-down node control circuit controls the potential of the first pull-down node, the second pull-down node control circuit controls the potential of the second pull-down node, and the driving control output circuit controls the driving control signal output terminal to provide a corresponding driving control signal under the control of the potential of the pull-up node, the potential of the first pull-down node and the potential of the second pull-down node.

In at least one embodiment of the present disclosure, the driving control signal generation circuit further includes a carry output circuit;
The carry output circuit is electrically connected to the pull-up node, the first pull-down node, the second pull-down node, the carry output terminal, the driving control clock signal line and the third voltage line respectively, and is configured to control to connect the driving control clock signal line and the carry output terminal under the control of the potential of the pull-up node, and control to connect the carry output terminal and the third voltage line under the control of the potential of the first pull-down node, and control to connect the carry output terminal and the third voltage line under the control of the potential of the second pull-down node.

In specific implementation, the driving control signal generation circuit may also include a carry output circuit, which controls the carry output terminal to provide a corresponding carry signal under the control of the potential of the pull-up node, the potential of the first pull-down node, and the potential of the second pull-down node, the carry signal can be used for cascading.

Optionally, the pull-up node control circuit is electrically connected to the input terminal, the frame reset line, the first pull-down node, the second pull-down node, the first reset terminal, the pull-up node and the third voltage line respectively, is configured to control the potential of the pull-up node under the control of the input signal provided by the input terminal, and control to connect the pull-up node and the third voltage line under the control of the frame reset signal provided by the frame reset line, control to connect the pull-up node and the third voltage line under the control of the potential of the first pull-down node, and control to connect the pull-up node and the third voltage line under the control of the potential of the second pull-down node, and control to connect the pull-up node and the third voltage line under the control of the first reset signal provided by the first reset terminal;
The first pull-down node control circuit is electrically connected to the first control voltage line, the first pull-down node, the pull-up node and the third voltage line respectively, and is configured to control the potential of the first pull-down node under the control of the first control voltage provided by the first control voltage line and the potential of the pull-up node;
The second pull-down node control circuit is electrically connected to the second control voltage line, the second pull-down node, the pull-up node and the third voltage line respectively, and is configured to control the potential of the second pull-down node under the control of the second control voltage provided by the second control voltage line and the potential of the pull-up node;
The driving control output circuit is also electrically connected to a second reset terminal, and is configured to control to connect the driving control signal output terminal and the second voltage line under the control of a second reset signal provided by the second reset terminal,
In at least one embodiment of the present disclosure, the third voltage line may be a second low voltage line, but is not limited thereto.

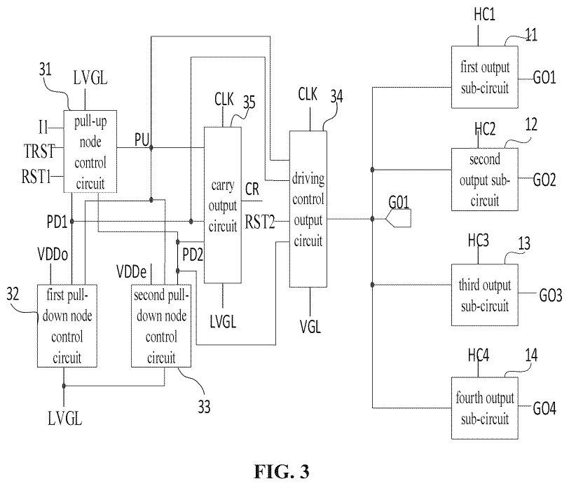

As shown in FIG. 3, based on at least one embodiment of the driving circuit shown in FIG. 1, the driving control signal generation circuit may include a pull-up node control circuit 31, a first pull-down node control circuit 32, a second pull-down node control circuit 33, a driving control output circuit 34 and a carry output circuit 35;
The pull-up node control circuit 31 is electrically connected to the input terminal I1, the frame reset line TRST, the first pull-down node PD1, the second pull-down node PD2, the first reset terminal RST1, the pull-up node PU and the second low voltage line LVGL respectively, is configured to control the potential of the pull-up node PU under the control of the input signal provided by the input terminal I1, and to control to connect the pull-up node PU and the second low voltage line LVGL under the control of the frame reset signal provided by the frame reset line TRST, and control to connect the pull-up node PU and the second low voltage line LVGL under the control of the potential of the first pull-down node PD1, control to connect the pull-up node PU and the second low voltage line LVGL under the control of the potential of the second pull-down node PD2, and the control to connect the pull-up node PU and the second low voltage line LVGL under the control of the first reset signal provided by the first reset terminal RST1;
The first pull-down node control circuit 32 is electrically connected to the first control voltage line VDDo, the first pull-down node PD1, the pull-up node PU and the second low voltage line LVGL respectively, and is configured to control the potential of the first pull-down node PD1 under the control of the first control voltage provided by the first control voltage line VDDo and the potential of the pull-up node PU;
The second pull-down node control circuit 33 is electrically connected to the second control voltage line VDDe, the second pull-down node PD2, the pull-up node PU and the second low voltage line LVGL respectively, and is configured to control the potential of the second pull-down node PD2 under the control of the second control voltage provided by the second control voltage line VDDe and the potential of the pull-up node PU;
The driving control output circuit 34 is respectively connected to the pull-up node PU, the first pull-down node PD1, the second pull-down node PD2, the driving control signal output terminal G01, the driving control clock signal line CLK and the first low voltage line VGL, is configured to control to connect the driving control clock signal line CLK and the driving control signal output terminal G01 under the control of the potential of the pull-up node PU, control to connect the driving control signal output terminal G01 and the first low voltage line VGL under the control of the potential of the pull-down node PD1, and control to connect the driving control signal output terminal G01 and the first low voltage line VGL under the control of the potential of the second pull-down node PD2;
The driving control output circuit 34 is also electrically connected to the second reset terminal RST2, and is configured to control to connect the driving control signal output terminal G01 and the first low voltage line VGL under the control of the second reset signal provided by the second reset terminal RST2;
The carry output circuit 35 is connected to the pull-up node PU, the first pull-down node PD1, the second pull-down node PD2, the carry output terminal CR, the driving control clock signal line CLK and the second low voltage line LVGL respectively, is configured to control to connect the driving control clock signal line CLK and the carry output terminal CR under the control of the potential of the pull-up node PU, and control to connect the carry output terminal CR and the second low voltage line under the control of the potential of the first pull-down node PD1, control to connect the carry output terminal CR and the second low voltage line LVGL under the control of the potential of the second pull-down node PD3.

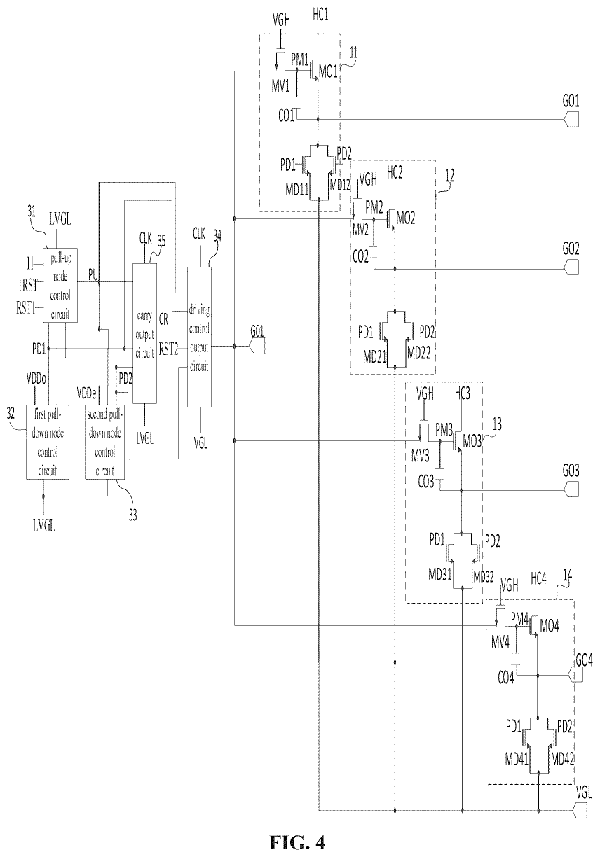

As shown in FIG. 4, based on at least one embodiment of the driving circuit shown in FIG. 3, the first output sub-circuit 11 may include a first output transistor MO1, a first on-off control transistor MV1, a first output capacitor CO1, a first first output pull-down transistor MD11 and a first second output pull-down transistor MD12;
The gate electrode of the first output transistor MO1 is electrically connected to the first pull-up control node PM1, and the drain electrode of the first output transistor MO1 is electrically connected to the first output clock signal line HC1, the source electrode of the first output transistor MO1 is electrically connected to the first driving signal output terminal GO1;
The gate electrode of the first output transistor MO1 is electrically connected to the driving control signal output terminal G01 through the first on-off control transistor MV1;
The gate electrode of the first on-off control transistor MV1 is electrically connected to the high voltage line VGH, and the drain electrode of the first on-off control transistor MV1 is electrically connected to the driving control signal output terminal G01, the source electrode of the first on-off control transistor MV1 is electrically connected to the gate electrode of the first output transistor MO1;
The first electrode plate of the first output capacitor CO1 is electrically connected to the gate electrode of the first output transistor MO1, and the second electrode plate of the first output capacitor CO1 is electrically connected to the source electrode of the first output transistor MO1;
The gate electrode of the first first output pull-down transistor MD11 is electrically connected to the first pull-down node PD1, and the drain electrode of the first first output pull-down transistor MD11 is connected to the first driving signal output terminal GO1, the source electrode of the first first output pull-down transistor MD11 is electrically connected to the first low voltage line VGL;
The gate electrode of the first second output pull-down transistor MD12 is electrically connected to the second pull-down node PD2, and the drain electrode of the first second output pull-down transistor MD12 is electrically connected to the first driving signal output terminal GO1, the source electrode of the first second output pull-down transistor MD12 is electrically connected to the first low voltage line VGL;
The second output sub-circuit 12 may include a second output transistor MO2, a second on-off control transistor MV2, a second output capacitor CO2, a second first output pull-down transistor MD21 and a second second output pull-down transistor MD22;
The gate electrode of the second output transistor MO2 is electrically connected to the second pull-up control node PM2, and the drain electrode of the second output transistor MO2 is electrically connected to the second output clock signal line HC2, the source electrode of the second output transistor MO2 is electrically connected to the second driving signal output terminal GO2;
The gate electrode of the second output transistor MO2 is electrically connected to the driving control signal output terminal GO1 through the second on-off control transistor MV2;
The gate electrode of the second on-off control transistor MV2 is electrically connected to the high voltage line VGH, and the drain electrode of the second on-off control transistor MV2 is electrically connected to the driving control signal output terminal G01, the source electrode of the second on-off control transistor MV2 is electrically connected to the gate electrode of the second output transistor MO2;
The first electrode plate of the second output capacitor CO2 is electrically connected to the gate electrode of the second output transistor MO2, and the second electrode plate of the second output capacitor CO2 is electrically connected to the source electrode of the second output transistor MO2;
The gate electrode of the second first output pull-down transistor MD21 is electrically connected to the first pull-down node PD1, and the drain electrode of the second first output pull-down transistor MD21 is connected to the second driving signal output terminal GO2, the source electrode of the second first output pull-down transistor MD21 is electrically connected to the first low voltage line VGL;
The gate electrode of the second second output pull-down transistor MD22 is electrically connected to the second pull-down node PD2, and the drain electrode of the second second output pull-down transistor MD22 is electrically connected to the second driving signal output terminal GO2, the source electrode of the second second output pull-down transistor MD22 is electrically connected to the first low voltage line VGL;
The third output sub-circuit 13 may include a third output transistor MO3, a third on-off control transistor MV3, a third output capacitor CO3, a third first output pull-down transistor MD31 and a third second output pull-down transistor MD32;
The gate electrode of the third output transistor MO3 is electrically connected to the third pull-up control node PM3, and the drain electrode of the third output transistor MO3 is electrically connected to the third output clock signal line HC3, the source electrode of the third output transistor MO3 is electrically connected to the third driving signal output terminal GO3;
The gate electrode of the third output transistor MO3 is electrically connected to the driving control signal output terminal GO1 through the third on-off control transistor MV3;
The gate electrode of the third on-off control transistor MV3 is electrically connected to the high voltage line VGH, and the drain electrode of the third on-off control transistor MV3 is electrically connected to the driving control signal output terminal G01, the source electrode of the third on-off control transistor MV3 is electrically connected to the gate electrode of the third output transistor MO3;
The first electrode plate of the third output capacitor CO3 is electrically connected to the gate electrode of the third output transistor MO3, and the second electrode plate of the third output capacitor CO3 is electrically connected to the source electrode of the third output transistor MO3;
The gate electrode of the third first output pull-down transistor MD31 is electrically connected to the first pull-down node PD1, and the drain electrode of the third first output pull-down transistor MD31 is connected to the third driving signal output terminal GO3, the source electrode of the third first output pull-down transistor MD31 is electrically connected to the first low voltage line VGL;
The gate electrode of the third second output pull-down transistor MD32 is electrically connected to the second pull-down node PD2, and the drain electrode of the third second output pull-down transistor MD32 is electrically connected to the third driving signal output terminal GO3, the source electrode of the third second output pull-down transistor MD32 is electrically connected to the first low voltage line VGL;
The fourth output sub-circuit 14 may include a fourth output transistor MO4, a fourth on-off control transistor MV4, a fourth output capacitor CO4, a fourth first output pull-down transistor MD41 and a fourth second output pull-down transistor MD42;
The gate electrode of the fourth output transistor MO4 is electrically connected to the fourth pull-up control node PM4, and the drain electrode of the fourth output transistor MO4 is electrically connected to the fourth output clock signal line HC4, the source electrode of the fourth output transistor MO4 is electrically connected to the fourth driving signal output terminal GO4;
The gate electrode of the fourth output transistor MO4 is electrically connected to the driving control signal output terminal G01 through the fourth on-off control transistor MV4;
The gate electrode of the fourth on-off control transistor MV4 is electrically connected to the high voltage line VGH, and the drain electrode of the fourth on-off control transistor MV4 is electrically connected to the driving control signal output terminal G01, the source electrode of the fourth on-off control transistor MV4 is electrically connected to the gate electrode of the fourth output transistor MO4;
The first electrode plate of the fourth output capacitor CO4 is electrically connected to the gate electrode of the fourth output transistor MO4, and the second electrode plate of the fourth output capacitor CO4 is electrically connected to the source electrode of the fourth output transistor MO4;
The gate electrode of the fourth first output pull-down transistor MD41 is electrically connected to the first pull-down node PD1, and the drain electrode of the fourth first output pull-down transistor MD41 is connected to the fourth driving signal output terminal GO4, the source electrode of the fourth first output pull-down transistor MD41 is electrically connected to the first low voltage line VGL;
The gate electrode of the fourth second output pull-down transistor MD42 is electrically connected to the second pull-down node PD2, and the drain electrode of the fourth second output pull-down transistor MD42 is electrically connected to the fourth driving signal output terminal GO4, the source electrode of the fourth second output pull-down transistor MD42 is electrically connected to the first low voltage line VGL.

In at least one embodiment of the driving circuit shown in FIG. 4, all transistors are n-type transistors, and all transistors are oxide thin film transistors, but this is not a limitation.

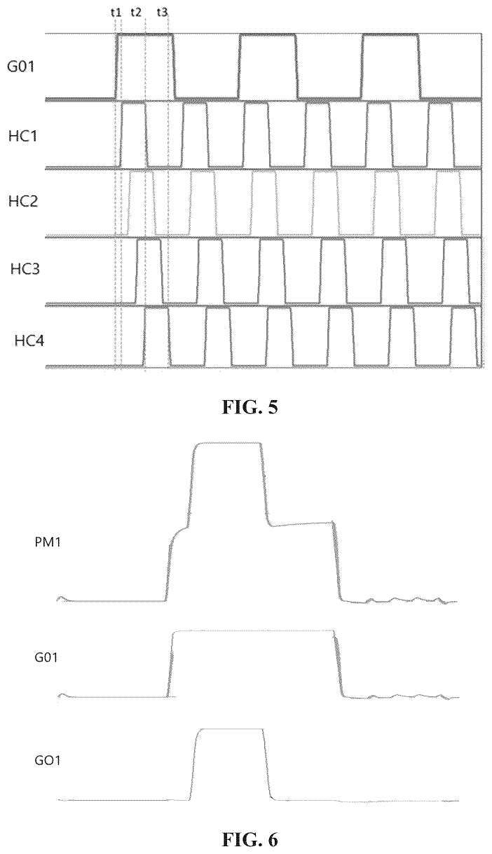

As shown in FIG. 5, when at least one embodiment of the driving circuit shown in FIG. 4 of the present disclosure is working,
In the first phase t1, G01 outputs a high voltage signal, MV1 is turned on, and charges PM1;
In the second phase t2, G01 outputs a high-voltage signal, MO1 is turned on, HC1 provides a high-voltage signal to charge GO1, and the bootstrap effect of CO1 is used to further increase the potential of PM1, and GO1 outputs a high-voltage signal; it should be noted that, at this time MV1 is in a off state to prevent the potential of PM1 from not rising by bootstrapping;
In the third phase t3, G01 outputs a high voltage signal, MO1 is still on, HC1 provides a low voltage signal, and GO1 outputs a low voltage signal;
In the phase after the third phase t3, the potential of PD1 or the potential of PD2 is a high voltage, MD11 and MD12 are turned on, and GO1 continues to discharge;
When at least one embodiment of the driving circuit shown in FIG. 4 of the present disclosure is working,
When G01 outputs a high voltage signal and HC2 outputs a high voltage signal, GO2 outputs a high voltage signal;
When G01 outputs a high voltage signal and HC3 outputs a low voltage signal, GO2 outputs a low voltage signal;
When G01 outputs a high voltage signal and HC3 outputs a high voltage signal, GO3 outputs a high voltage signal;
When G01 outputs a high voltage signal and HC3 outputs a low voltage signal, GO3 outputs a low voltage signal;
When G01 outputs a high voltage signal and HC4 outputs a high voltage signal, GO4 outputs a high voltage signal;
When G01 outputs a high voltage signal and HC4 outputs a low voltage signal, GO4 outputs a low voltage signal.

In at least one embodiment of the driving circuit shown in FIG. 4, the function of the on-off control transistor is explained as follows (taking MV1 as an example):
At the beginning of the first phase t1, the potential of PM1 is a low voltage. For MV1, its gate-source voltage is greater than the threshold voltage of MV1, and the driving control signal output by G01 charges PM1; when the potential of PM1 is bootstrapped, the potential of PM1 is greater than the voltage value of the high voltage signal provided by VGH, and MV1 is in an off state;
If MV1 is not set, the potential of PM1 cannot complete the bootstrapping. The reason is that the transistor whose gate electrode is electrically connected to the pull-up node PU included in the driving control output circuit on the left is in an on state, and the driving control clock signal line output a high-voltage signal, that is an active signal, and the bootstrap charge will flow to the driving control clock signal line through the transistor, making it impossible to complete the bootstrapping of PM2.

FIG. 6 is a timing diagram of the driving control signal provided by G01, the potential of PM1, and the first driving signal output by GO1 when at least one embodiment of the driving circuit shown in FIG. 4 is working.

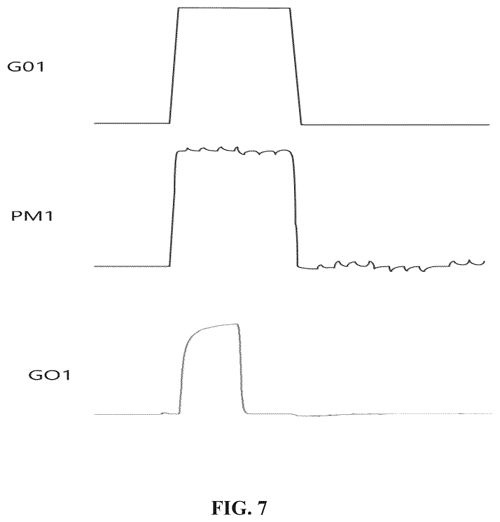

FIG. 7 is a timing diagram of the driving control signal provided by G01, the potential of PM1, and the first driving signal output by GO1 when at least one embodiment of the driving circuit shown in FIG. 4 is not provided with each on-off control transistor. As shown in FIG. 7, when MV1 is not set, the potential of PM1 cannot be raised by bootstrapping.

Optionally, the pull-up node control circuit includes a first transistor, a second transistor, a third transistor, a fourth transistor and a fifth transistor;
a control electrode of the first transistor is electrically connected to a first electrode of the first transistor and the input terminal, and a second electrode of the first transistor is electrically connected to the pull-up node;
a control electrode of the second transistor is electrically connected to the first reset terminal, a first electrode of the second transistor is electrically connected to the pull-up node, and a second electrode of the second transistor is electrically connected to the third voltage line;
a control electrode of the third transistor is electrically connected to the frame reset terminal, a first electrode of the third transistor is electrically connected to the pull-up node, and a second electrode of the third transistor is electrically connected to the third voltage line;
a control electrode of the fourth transistor is electrically connected to the first pull-down node, a first electrode of the fourth transistor is electrically connected to the pull-up node, and a second electrode of the fourth transistor is electrically connected to the third voltage line;
a control electrode of the fifth transistor is electrically connected to the second pull-down node, a first electrode of the fifth transistor is electrically connected to the pull-up node, and a second electrode of the fifth transistor is electrically connected to the third voltage line;
The first pull-down node control circuit includes a sixth transistor and a seventh transistor;
a control electrode of the sixth transistor and a first electrode of the sixth transistor are electrically connected to the first control voltage line, and a second electrode of the sixth transistor is electrically connected to the first pull-down node;
a control electrode of the seventh transistor is electrically connected to the pull-up node, a first electrode of the seventh transistor is electrically connected to the first pull-down node, and a second electrode of the seventh transistor is electrically connected to the third voltage line;
The second pull-down node control circuit includes an eighth transistor and a ninth transistor;
a control electrode of the eighth transistor and a first electrode of the eighth transistor are electrically connected to the second control voltage line, and a second electrode of the eighth transistor is electrically connected to the second pull-down node;
a control electrode of the ninth transistor is electrically connected to the pull-up node, a first electrode of the ninth transistor is electrically connected to the second pull-down node, and a second electrode of the ninth transistor is electrically connected to the third voltage line.

In at least one embodiment of the present disclosure, the ratio between the channel width to length ratio of the seventh transistor and the channel width to length ratio of the sixth transistor is greater than or equal to 6, and the ratio between the channel width to length of the ninth transistor and the channel width to length ratio of the eighth transistor is greater than or equal to 6.

Optionally, the first pull-down node control circuit further includes a tenth transistor, and the second pull-down node control circuit further includes an eleventh transistor;
a control electrode of the tenth transistor is electrically connected to the input terminal, a first electrode of the tenth transistor is electrically connected to the first pull-down node, and a second electrode of the tenth transistor is electrically connected to the third voltage line;
a control electrode of the eleventh transistor is electrically connected to the input terminal, a first electrode of the eleventh transistor is electrically connected to the second pull-down node, and a second electrode of the eleventh transistor is electrically connected to the third voltage line.

Optionally, the carry output circuit includes a twelfth transistor, a thirteenth transistor and a fourteenth transistor;
a control electrode of the twelfth transistor is electrically connected to the pull-up node, a first electrode of the twelfth transistor is electrically connected to the driving control clock signal line, and a second electrode of the twelfth transistor is electrically connected to the carry output terminal;
a control electrode of the thirteenth transistor is electrically connected to the first pull-down node, a first electrode of the thirteenth transistor is electrically connected to the carry output terminal, and a second electrode of the thirteenth transistor is electrically connected to the third voltage line;
a control electrode of the fourteenth transistor is electrically connected to the second pull-down node, a first electrode of the fourteenth transistor is electrically connected to the carry output terminal, and a second electrode of the fourteenth transistor is electrically connected to the third voltage line;
The driving control output circuit includes a fifteenth transistor, a sixteenth transistor, a seventeenth transistor, an eighteenth transistor and a first capacitor;
a control electrode of the fifteenth transistor is electrically connected to the pull-up node, a first electrode of the fifteenth transistor is electrically connected to the driving control clock signal line, and a second electrode of the fifteenth transistor is electrically connected to the driving control signal output terminal;
a control electrode of the sixteenth transistor is electrically connected to the first pull-down node, a first electrode of the sixteenth transistor is electrically connected to the driving control signal output terminal, and a second electrode of the sixteenth transistor is electrically connected to the second voltage line;
a control electrode of the seventeenth transistor is electrically connected to the second pull-down node, a first electrode of the seventeenth transistor is electrically connected to the driving control signal output terminal, and a second electrode of the seventeenth transistor is electrically connected to the second voltage line;
a control electrode of the eighteenth transistor is electrically connected to the second reset terminal, a first electrode of the eighteenth transistor is electrically connected to the driving control signal output terminal, and a second electrode of the eighteenth transistor is electrically connected to the second voltage line;
a first electrode plate of the first capacitor is electrically connected to the pull-up node, and a second electrode plate of the first capacitor is electrically connected to the driving control signal output terminal.

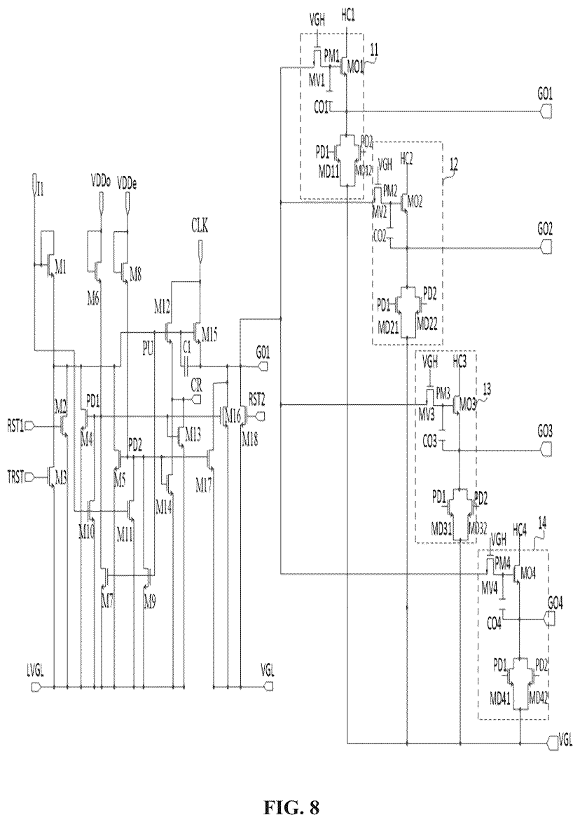

As shown in FIG. 8, based on at least one embodiment of the driving circuit shown in FIG. 4, the pull-up node control circuit includes a first transistor M1, a second transistor M2, a third transistor M3, a fourth transistor M4 and a fifth transistor M5;
The gate electrode of the first transistor M1 and the drain electrode of the first transistor M1 are electrically connected to the input terminal I1, and the source electrode of the first transistor M1 is electrically connected to the pull-up node PU;
The source electrode of the second transistor M2 is electrically connected to the first reset terminal RST1, the drain electrode of the second transistor M2 is electrically connected to the pull-up node PU, and the source electrode of the second transistor M2 is electrically connected to the second low voltage line LVGL;
The gate electrode of the third transistor M3 is electrically connected to the frame reset terminal TRST, the drain electrode of the third transistor M3 is electrically connected to the pull-up node PU, and the source electrode of the third transistor M3 is electrically connected to the second low voltage line LVGL;
The gate electrode of the fourth transistor M4 is electrically connected to the first pull-down node PD1, the drain electrode of the fourth transistor M4 is electrically connected to the pull-up node PU, and the source electrode of the fourth transistor M4 is electrically connected to the second low voltage line LVGL;
The gate electrode of the fifth transistor M5 is electrically connected to the second pull-down node PD2, the drain electrode of the fifth transistor M5 is electrically connected to the pull-up node PU, and the source electrode of the fifth transistor M5 is electrically connected to the second low voltage line LVGL;
The first pull-down node control circuit includes a sixth transistor M6 and a seventh transistor M7;
The gate electrode of the sixth transistor M6 and the drain electrode of the sixth transistor M6 are electrically connected to the first control voltage line VDDo, and the source electrode of the sixth transistor M6 is electrically connected to the first pull-down node PD1;
The gate electrode of the seventh transistor M7 is electrically connected to the pull-up node PU, the drain electrode of the seventh transistor M7 is electrically connected to the first pull-down node PD1, and the source electrode of the seventh transistor M7 is electrically connected to the second low voltage line LVGL;
The second pull-down node control circuit includes an eighth transistor M8 and a ninth transistor M9;
The gate electrode of the eighth transistor M8 and the drain electrode of the eighth transistor M8 are electrically connected to the second control voltage line VDDe, and the source electrode of the eighth transistor M8 is electrically connected to the second pull-down node PD2;
The gate electrode of the ninth transistor M9 is electrically connected to the pull-up node PU, the drain electrode of the ninth transistor M9 is electrically connected to the second pull-down node PD2, and the source electrode of the ninth transistor M9 is electrically connected to the second low voltage line LVGL;
The first pull-down node control circuit further includes a tenth transistor M10, and the second pull-down node control circuit 33 further includes an eleventh transistor M11;
The gate electrode of the tenth transistor M10 is electrically connected to the input terminal I1, the drain electrode of the tenth transistor M10 is electrically connected to the first pull-down node PD1, and the source electrode of the tenth transistor M10 is electrically connected to the second low voltage line LVGL;
The gate electrode of the eleventh transistor M11 is electrically connected to the input terminal 11, the drain electrode of the eleventh transistor M11 is electrically connected to the second pull-down node PD2, and the source electrode of the eleventh transistor M11 is electrically connected to the second voltage line LVGL;
The carry output circuit 35 includes a twelfth transistor M12, a thirteenth transistor M13, and a fourteenth transistor M14;
The gate electrode of the twelfth transistor M12 is electrically connected to the pull-up node PU, and the drain electrode of the twelfth transistor M12 is electrically connected to the driving control clock signal line CLK, the source electrode of the twelfth transistor M12 is electrically connected to the carry output terminal CR;
The gate electrode of the thirteenth transistor M13 is electrically connected to the first pull-down node PD1, and the drain electrode of the thirteenth transistor M13 is electrically connected to the carry output terminal CR, and the source electrode of the thirteenth transistor M13 is electrically connected to the second low voltage line LVGL;
The gate electrode of the fourteenth transistor M14 is electrically connected to the second pull-down node PD2, the drain electrode of the fourteenth transistor M14 is electrically connected to the carry output terminal CR, and the source electrode of the fourteenth transistor M14 is electrically connected to the second low voltage line LVGL;
The driving control output circuit includes a fifteenth transistor M15, a sixteenth transistor M16, a seventeenth transistor M17, an eighteenth transistor M18 and a first capacitor C1;
The gate electrode of the fifteenth transistor M15 is electrically connected to the pull-up node PU, and the drain electrode of the fifteenth transistor M15 is electrically connected to the driving control clock signal line CLK, and the source electrode of the fifteenth transistor MIS is electrically connected to the driving control signal output terminal G01;
The gate electrode of the sixteenth transistor M16 is electrically connected to the first pull-down node PD1, and the drain electrode of the sixteenth transistor M16 is electrically connected to the driving control signal output terminal G01, the source electrode of the sixteenth transistor M16 is electrically connected to the first low voltage line VGL;
The gate electrode of the seventeenth transistor M17 is electrically connected to the second pull-down node PD2, and the drain electrode of the seventeenth transistor M17 is electrically connected to the driving control signal output terminal G01, the source electrode of the seventeenth transistor M17 is electrically connected to the first low voltage line VGL;
The gate electrode of the eighteenth transistor M18 is electrically connected to the second reset terminal RST2, and the drain electrode of the eighteenth transistor M18 is electrically connected to the driving control signal output terminal G01, the source electrode of the eighteenth transistor M18 is electrically connected to the first low voltage line VGL;
The first electrode plate of the first capacitor C1 is electrically connected to the pull-up node PU, and the second electrode plate of the first capacitor C1 is electrically connected to the driving control signal output terminal G01.

In at least one embodiment of the driving circuit shown in FIG. 8, the ratio between the channel width and length ratio of the seventh transistor M7 and the channel width and length ratio of the sixth transistor M6 is greater than or equal to 6, so that when the potential of the pull-up node PU is a high voltage, the potential of the first pull-down node PD1 may be a low voltage; the ratio between the channel width-to-length ratio of the ninth transistor M9 and the channel width-to-length ratio of the eighth transistor M8 is greater than or equal to 6, so that when the potential of the pull-up node PU is a high voltage, the potential of the second pull-down node PD2 can be a low voltage. For example, the ratio between the channel width and length ratio of the seventh transistor M7 and the channel width and length ratio of the sixth transistor M6 may be equal to 10, and the ratio between the channel width and length ratio of the ninth transistor M9 and the channel width and length ratio of the eighth transistor M8 may be equal to 10.

In at least one embodiment of the driving circuit shown in FIG. 8, all transistors are n-type transistors, and all transistors are oxide thin film transistors, but this is not a limitation.

In at least one embodiment of the driving circuit shown in FIG. 8, the width-to-length ratio of M1 may be greater than or equal to 12 and less than or equal to 15, the width-to-length ratio of M2 may be greater than or equal to 2 and less than or equal to 5, and the width-to-length ratio of M15 may be greater than or equal to 100 and less than or equal to 200, the width-to-length ratio of M18 can be greater than or equal to 4 and less than or equal to 6, the width-to-length ratio of M6 and the width-to-length ratio of M8 can be greater than or equal to 0.8 and less than or equal to 1.2, the width-to-length ratio of M7 and the width-to-length ratio of M9 can be greater than or equal to 4 and less than or equal to 4.8. The width-to-length ratio of M10 and the width-to-length ratio of M11 can be greater than or equal to 3 and less than or equal to 5. The width-to-length ratio of M4 and the width-to-length ratio of M5 can be greater than or equal to 13 and less than or equal to 15, the width-to-length ratio of M12 can be greater than or equal to 70 and less than or equal to 90, the width-to-length ratio of M13 and the width-to-length ratio of M14 can be greater than or equal to 1 and less than or equal to 3, the width-to-length ratio of M16 and the width-to-length ratio of M17 can be greater than or equal to 7 and less than or equal to 9, the width-to-length ratio of M3 can be greater than or equal to 0.8 and less than or equal to 1.2. The width-to-length ratio of each on-off control transistor can be greater than or equal to 40 and less than or equal to 80. The width-to-length ratio of each output transistor can be greater than or equal to 100 and less than is equal to 200, the width-to-length ratio of each output pull-down transistor can be greater than or equal to 7 and less than or equal to 9, the capacitance value of the first capacitor can be greater than or equal to 1 pF and less than or equal to 3 pF, and the capacitance value of each output capacitor can be greater than or equal to 1 pF and less than or equal to 3 pF.

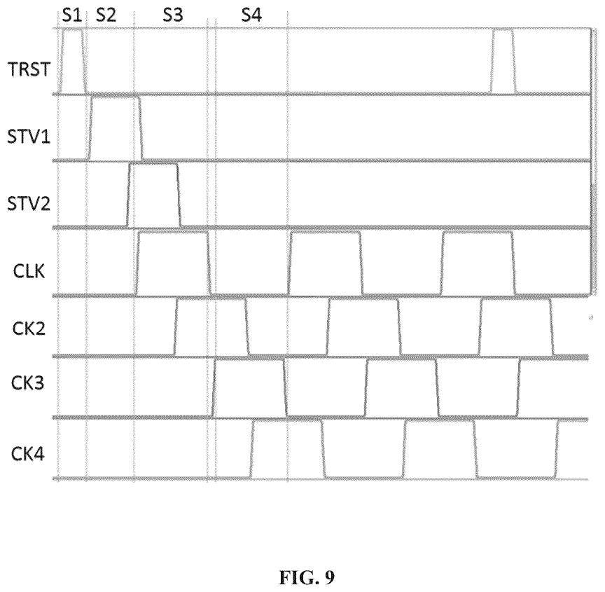

As shown in FIG. 9, when at least one embodiment of the driving circuit shown in FIG. 8 of the present disclosure is working, the display period may include a first display phase S1, a second display phase S2, a third display phase S3, and a fourth display phase S4 and a fifth display phase S5;
In the first display phase S1, TRST provides a high voltage signal, M3 is turned on, other transistors are turned off, the pull-up nodes in all rows of driving circuits are written with low voltage signals, TRST is connected to all rows of driving circuits, and the noise reduction is performed on all rows of driving circuits before a frame, the frame reset signal provided by TRST is configured to prevent signal abnormalities at the front end of the gate driving architecture (such as the timing control chip), causing noise to be transmitted to the next frame;
In the second display phase S2, STV1 is a high-voltage signal (the input terminal I1 in FIG. 8 is connected to the first start signal STV1), M1 is turned on, M10 and M11 are turned on, other transistors are turned off, and M1 writes a high-voltage signal for the PU. M10 writes a low-voltage signal for PD1, and M11 writes a low-voltage signal for PD2. This design can reduce the discharge current through M10 and M11 when charging the PU; when the PU is charged to a certain level (usually the potential of the PU rises to 2V or above), M15 is turned on, G01 outputs a low-voltage signal, M7 and M9 are turned on, and low-voltage signals are written into PD1 and PD2;
In the third display phase S3, M15 is turned on, CLK outputs a high-voltage signal, MIS is turned on, M7 and M9 remain at an on state, G01 outputs a high-voltage signal, and at the same time, the potential of PU further increases under the bootstrap action of C1;
In the fourth display phase S4, RST1 provides a high voltage signal, M2 is turned on, to write a low voltage signal into the PU, M7 and M9 are turned off, VDDo writes a high voltage to PD1 through M6, VDDe writes a high voltage to PD2 through M8, M4, M5, M13, M14, M16 and M17 are all turned on to continuously reduce noise for PU, CR and G01. The potential of PU is a low voltage, and both CR and G01 output low voltage signals;
In a phase after the fourth display phase S4, the potential of PD1 and the potential of PD2 are both high voltage, and M4, M5, M13, M14, M16 and M17 are continuously controlled to be turned on, and noise reduction for PU, CR and GO1 continues until this frame ends.

In FIG. 9, the signal labeled CK2 is the second driving control clock signal, the signal labeled CK3 is the third driving control clock signal, and the signal labeled CK4 is the fourth driving control clock signal;
In specific implementation, when the first stage of driving circuit is electrically connected to CLK in FIG. 9, the second stage of driving circuit can be connected to CK2, the third stage of driving circuit can be connected to CK3, and the fourth stage of driving circuit can be connected to CK4; A is a positive integer;
The input terminal of the first stage of driving circuit is connected to the first start signal STV1, and the input terminal of the second stage of driving circuit is connected to the second start signal STV2 (STV2 is shown in FIG. 9);
The input terminal of the third stage of driving circuit can be electrically connected to the driving control signal output terminal of the first stage of driving circuit, and the input terminal of the fourth stage of driving circuit can be electrically connected to the driving control signal output terminal of the second stage of driving circuit;
The first reset terminal of the first stage of driving circuit can be electrically connected to the driving control signal output terminal of the third stage of driving circuit, and the first reset terminal of the second stage of driving circuit can be electrically connected to the driving control signal output terminal of the fourth stage of driving circuit.

In at least one embodiment of the present disclosure, the driving circuit includes an input terminal and a driving control signal output terminal;
The input terminal of the B stage of driving circuit is electrically connected to the driving control signal output terminal of the B−2 stage of driving circuit, and the reset terminal of the A stage of driving circuit is electrically connected to the driving control signal output terminal of the A+2 stage of driving circuit.
A is a positive integer, B is an integer greater than 2;
The input terminal of the first stage of driving circuit is connected to the first start signal, and the input terminal of the second stage of driving circuit is connected to the second start signal.

The display substrate according to the embodiment of the present disclosure includes a base substrate and the above-mentioned a plurality of stages of driving circuit provided on the base substrate.

In at least one embodiment of the present disclosure, the display substrate includes a peripheral area and a display area; the driving circuit includes a driving control signal generation circuit and a multi-channel output circuit;
The multi-channel output circuit and the driving control signal generation circuit are arranged in the peripheral area;
The multi-channel output circuit is arranged on a side of the driving control signal generation circuit close to the display area.

In specific implementation, the driving circuit can be arranged in the peripheral area, and the multi-channel output circuit is arranged on a side of the driving control signal generating circuit close to the display area, so that the driving signal output terminals included in the multi-channel output circuit respectively are electrically connected to the rows of gate lines in the display area.

In at least one embodiment of the present disclosure, the multi-channel output circuit includes N output sub-circuits and N output clock signal lines; N is an integer greater than 1;
The output clock signal line is arranged on a side of the output sub-circuit close to the display area, and the output clock signal line extends along the first direction.

In specific implementation, each of the output clock signal lines is arranged on the side of the output sub-circuit close to the display area, which is beneficial to reducing the crossover distance between the output sub-circuit and the output clock signal line and saving space.

In at least one embodiment of the present disclosure, the nth output sub-circuit may include an nth output transistor, and the nth output transistor may be arranged between the driving control signal generation circuit and the display area;
n is a positive integer less than or equal to N.

Optionally, the nth output sub-circuit includes an nth output transistor; n is a positive integer less than or equal to N;
The active layer pattern of the nth output transistor includes at least one mutually independent active portion; the active portion extends along the first direction.

In at least one embodiment of the present disclosure, the extension direction of the active portion and the extension direction of the output clock signal line may both be a first direction. For example, the first direction may be vertical, but not limited thereto.

In at least one embodiment of the present disclosure, the active layer patterns of the output transistors respectively included in the N output sub-circuits are arranged along the first direction.

Optionally, the nth output sub-circuit further includes an nth output pull-down unit, and the nth output pull-down unit includes an nth first output pull-down transistor and an nth second output pull-down transistor;
The active layer pattern of the nth first output pull-down transistor and the active layer pattern of the nth second output pull-down transistor are arranged along the first direction;
The active layer pattern of the nth first output pull-down transistor and the active layer pattern of the nth second output pull-down transistor both extend along the first direction.

In specific implementation, the output pull-down units respectively included in the N output sub-circuits are arranged along the first direction.

In at least one embodiment of the present disclosure, the active layer pattern of each transistor extends along the first direction, and the active layer patterns of the output transistors respectively included in the N output sub-circuits are arranged along the first direction. The active layer pattern of the nth first output pull-down transistor and the active layer pattern of the nth second output pull-down transistor are arranged along the first direction, and the output pull-down units respectively included in the N output sub-circuits are arranged along the first direction, and the active layer patterns of the transistors are very dispersed, which is beneficial to the heat dissipation of the active layer.

In specific implementation, the display substrate includes a plurality of signal lines, the signal lines are electrically connected to the driving control signal generation circuit included in the driving circuit, and the signal lines extend along the first direction;
The shortest distance along the second direction between the gate electrode of the transistor included in the driving control signal generation circuit and the signal line closest to the transistor in the driving control signal generation circuit is greater than a first predetermined distance;
The first direction intersects the second direction;
The gate electrode of the transistor and the signal line are located on the same layer.

In at least one embodiment of the present disclosure, the shortest distance along the second direction between the gate electrode of the transistor included in the driving control signal generation circuit and the signal line closest to the transistor in the driving control signal generation circuit is greater than the first predetermined distance, which is helpful to prevent electrostatic discharge (ESD) of wiring from damaging the transistor.

For example, the first predetermined distance may be 40 μm, and the second direction may be a horizontal direction, but is not limited thereto.

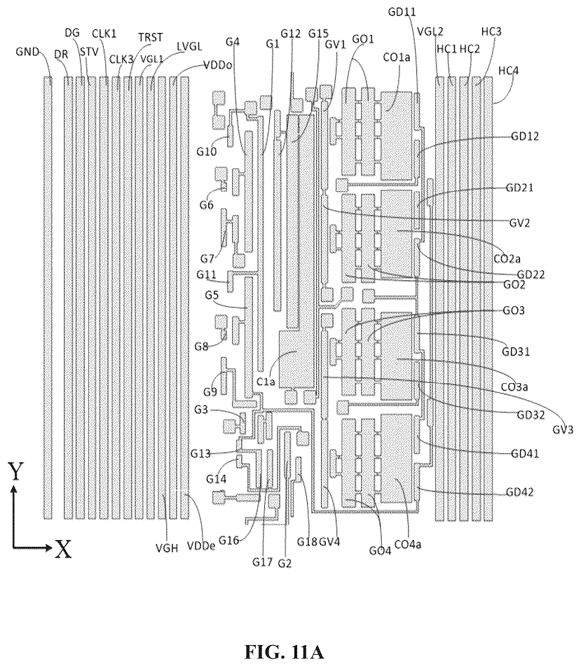

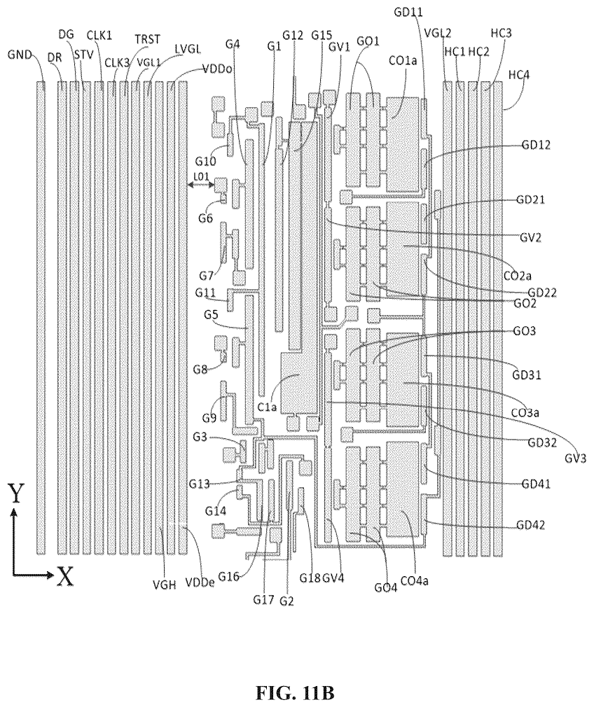

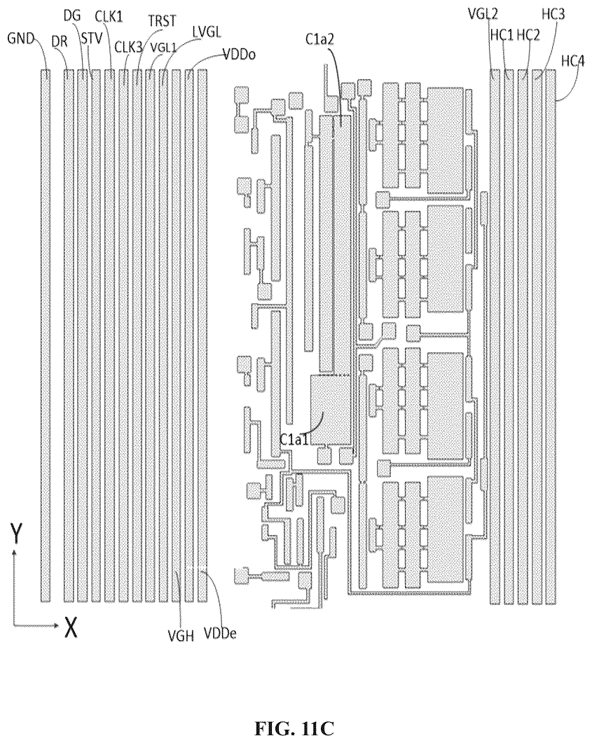

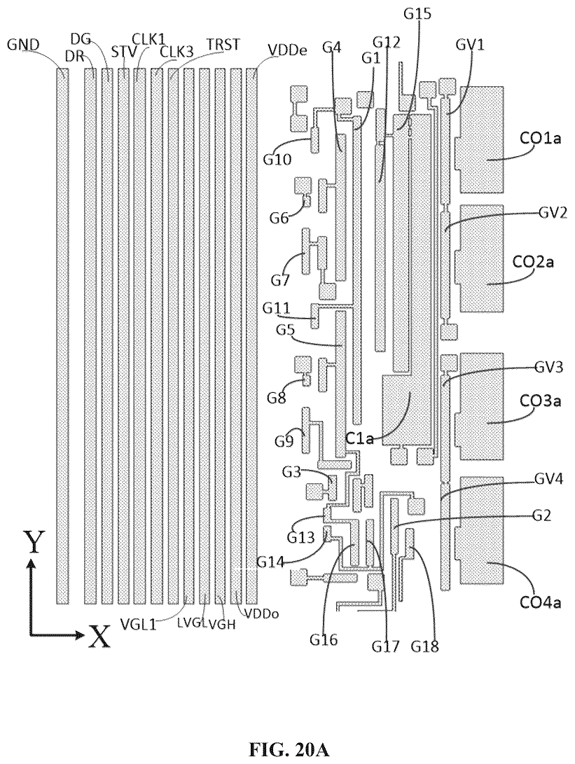

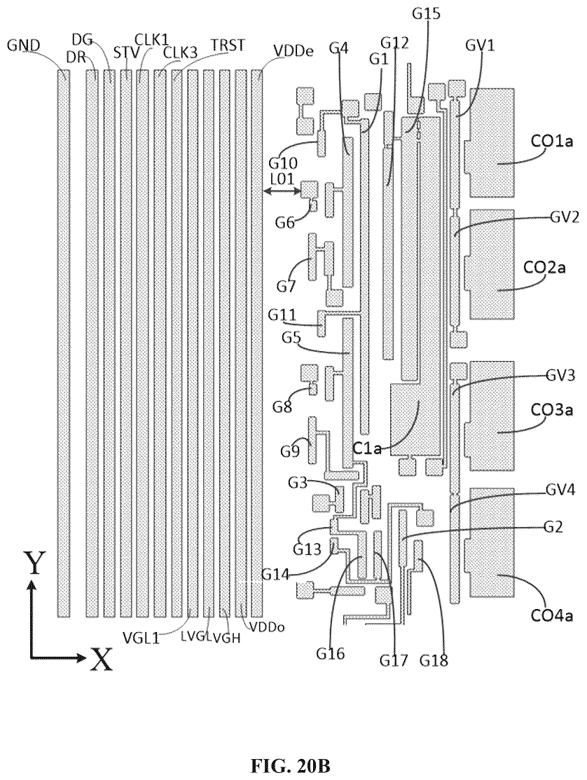

As shown in FIGS. 11B and 20B, G6 is the closest to VDDE, and the shortest distance in the horizontal direction between G6 and VDDE is the first shortest distance L01, and L01 is greater than 40 μm.

In at least one embodiment of the present disclosure, the active layer patterns of the transistors in the driving control signal generation circuit included in the driving circuit may all extend along the first direction, but are not limited to this.

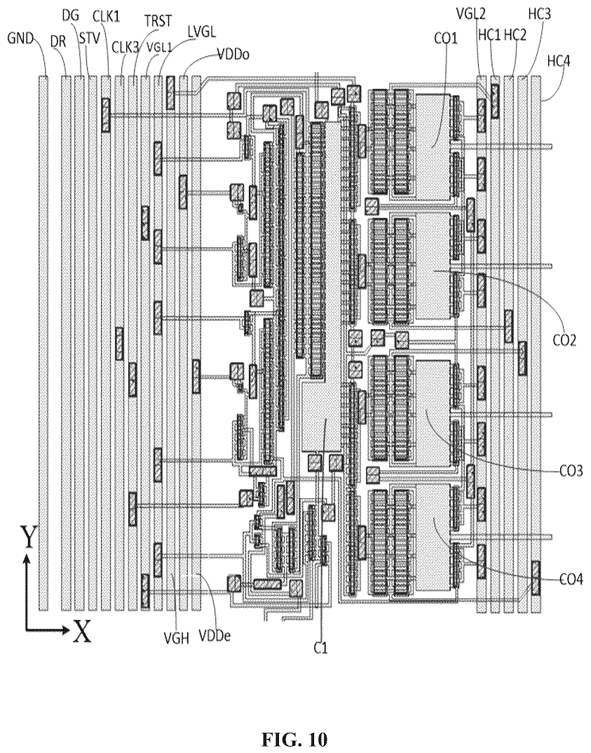

FIG. 10 is a top plan view of the driving circuit shown in FIG. 8 according to at least one embodiment of the present disclosure.

In FIG. 10 and FIG. 11A, the one labeled GND is the ground, the one labeled DR is the first peripheral test line, the one labeled DG is the second peripheral test line, the one labeled STV is the start signal line, and the one labeled CLK1 is the first driving control clock signal line, the one labeled TRST is the frame reset line, the one labeled VGL1 is the first first low voltage line, the one labeled LVGL is the second low voltage line, and the one labeled VGH is the high voltage line, the one labeled VDDo is the first control voltage line, the one labeled VDDe is the second control voltage line; the one labeled VGL2 is the second first low voltage line, the one labeled HC1 is the first output clock signal line, the line labeled HC2 is the second output clock signal line, the line labeled HC3 is the third output clock signal line, and the line labeled HC4 is the fourth output clock signal line;
In FIG. 10, the one labeled CO1 is the first output capacitor, the one labeled CO2 is the second output capacitor, the one labeled CO3 is the third output capacitor, and the one labeled CO4 is the fourth output capacitor;
The one labeled C1 is the first capacitor.

FIGS. 11A, 11B, and 11C are planar top views of the gate metal layer in FIG. 10.

In FIG. 11A, the one labeled GO1 is the gate electrode of the first output transistor MO1, the one labeled GO2 is the gate electrode of the second output transistor MO2, the one labeled GO3 is the gate electrode of the third output transistor MO3, and the one labeled GO4 is the gate electrode of the fourth output transistor MO4;
The one labeled GD11 is the gate electrode of the first first output pull-down transistor MD11, the one labeled GD12 is the gate electrode of the first second output pull-down transistor MD12, and the one labeled GD21 is the gate electrode of the second first output pull-down transistor MD21. The one labeled GD22 is the gate electrode of the second second output pull-down transistor MD22, the one labeled GD31 is the gate electrode of the third first output pull-down transistor MD31, and the one labeled GD32 is the gate electrode of the third second output pull-down transistor MD22. The one labeled GD41 is the gate electrode of the fourth first output pull-down transistor MD41, and the one labeled GD42 is the gate electrode of the fourth second output pull-down transistor MD42;
The one labeled GV1 is the gate electrode of the first on-off control transistor MV1, the one labeled GV2 is the gate electrode of the second on-off control transistor MV2, the one labeled GV3 is the gate electrode of the third on-off control transistor MV3, the one labeled GV4 is the gate electrode of the fourth on-off control transistor MV4;
The one labeled G1 is the gate electrode of the first transistor M1, the one labeled G2 is the gate electrode of the second transistor M2, the one labeled G3 is the gate electrode of the third transistor M3, and the one labeled G4 is the gate electrode of the fourth transistor M4. The one labeled G5 is the gate electrode of the fifth transistor M5, the one labeled G6 is the gate electrode of the sixth transistor M6, the one labeled G7 is the gate electrode of the seventh transistor M7, and the one labeled G8 is the gate electrode of the eighth transistor M8. The one labeled G9 is the gate electrode of the ninth transistor M9, the one labeled G10 is the gate electrode of the tenth transistor M10, the one labeled G11 is the gate electrode of the eleventh transistor M11, and the one labeled G12 is the gate electrode of the twelve transistor M12, the one labeled G13 is the gate electrode of the thirteenth transistor M13, the one labeled G14 is the gate electrode of the fourteenth transistor M14, the one labeled G15 is the gate electrode of the fifteenth transistor M15, the one labeled G16 is the gate electrode of the sixteenth transistor M16, the one labeled G17 is the gate electrode of the seventeenth transistor M17, and the one labeled G18 is the gate electrode of the eighteenth transistor M18.

In FIG. 11A, the one labeled CO1a is the first electrode plate of CO1, the one labeled CO2a is the first electrode plate of CO2, the one labeled CO3a is the first electrode plate of CO3, and the one labeled CO4a is the first electrode plate of CO4. The one labeled C1a is the first electrode plate of C1.

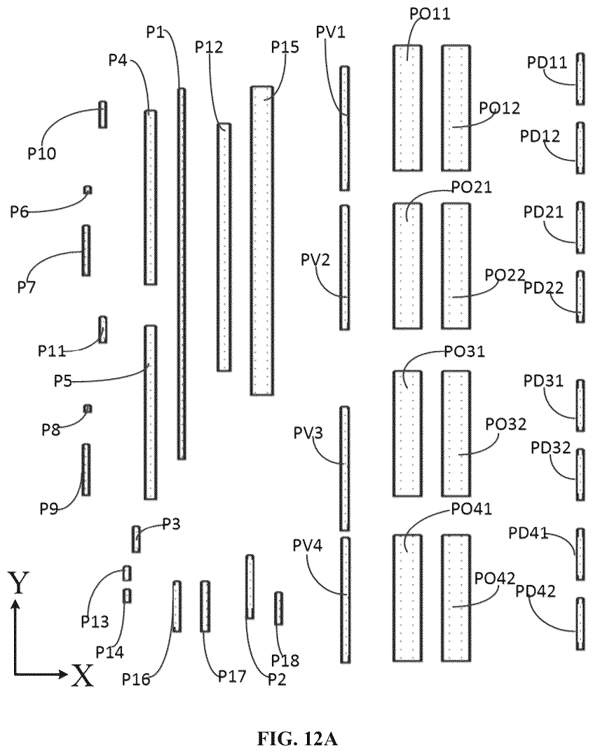

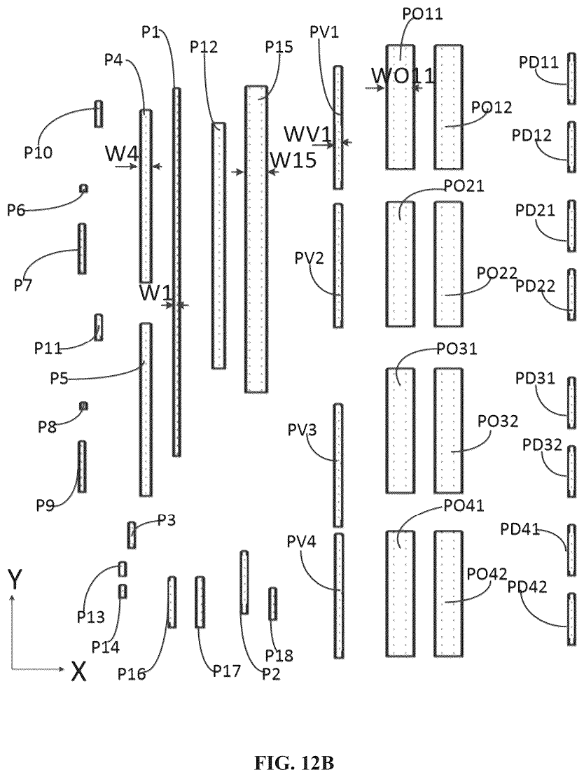

FIGS. 12A and 12B are planar top views of the semiconductor layer in FIG. 10.

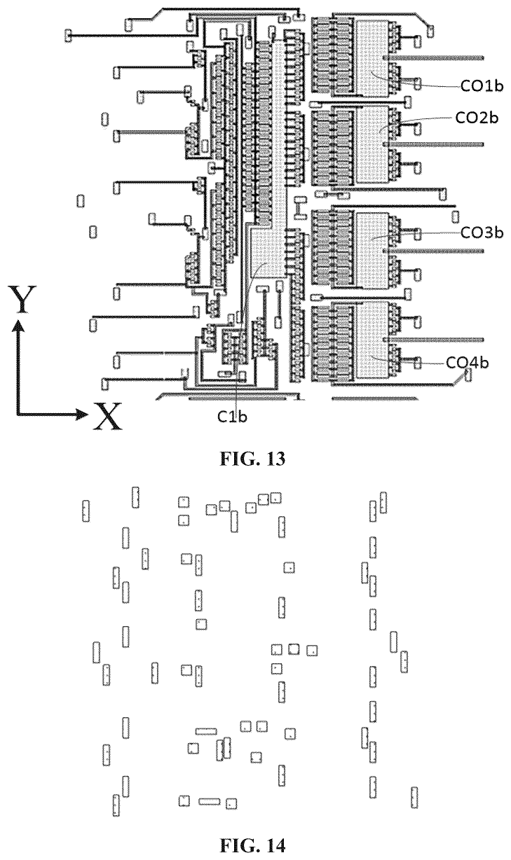

FIG. 13 is a top plan view of the source-drain metal layer in FIG. 10.

In FIG. 12A, the one labeled PO11 is the first active portion included in the active layer pattern of the first output transistor MO1, and the one labeled PO12 is the second active portion included in the active layer pattern of the first output transistor MO1; the one labeled PO21 is the first active portion included in the active layer pattern of the second output transistor MO2, the one labeled PO22 is the second active portion included in the active layer pattern of the second output transistor MO2; the one labeled PO31 is the first active portion included in the active layer pattern of the third output transistor MO3. The one labeled PO32 is a second active portion included in the active layer pattern of the third output transistor MO3. The one labeled PO41 is the first active portion included in the active layer pattern of fourth output transistor MO4, and the one labeled PO42 is a second active portion included in the active layer pattern of the fourth output transistor MO4;
The one labeled PD11 is the active layer pattern of the first first output pull-down transistor MD11, the one labeled PD12 is the active layer pattern of the first second output pull-down transistor MD12, and the one labeled PD21 is the active layer pattern of the second first output pull-down transistor MD21, the one labeled PD22 is the active layer pattern of the second second output pull-down transistor MD22, and the one labeled PD31 is the active layer pattern of the third first output pull-down transistor MD31, the one labeled PD32 is the active layer pattern of the third second output pull-down transistor M32, the one labeled PD41 is the active layer pattern of the fourth first output pull-down transistor MD41, and the one labeled PD42 is the active layer pattern of the fourth second output pull-down transistor MD42;
The one labeled PV1 is the active layer pattern of the first on-off control transistor MV1, the one labeled PV2 is the active layer pattern of the second on-off control transistor MV2, the one labeled PV3 is the active layer pattern of the third on-off control transistor MV3, the one labeled PV4 is the active layer pattern of the fourth on-off control transistor MV4;
The one labeled P1 is the active layer pattern of the first transistor M1, the one labeled P2 is the active layer pattern of the second transistor M2, the one labeled P3 is the active layer pattern of the third transistor M3, the one labeled P4 is the active layer pattern of the fourth transistor M4, the one labeled P5 is the active layer pattern of the fifth transistor M5, the one labeled P6 is the active layer pattern of the sixth transistor M6, the one labeled P7 is the active layer pattern of the seventh transistor M7. The one labeled P8 is the active layer pattern of the eighth transistor M8, the one labeled P9 is the active layer pattern of the ninth transistor M9, the one labeled P10 is the active layer pattern of the tenth transistor M10, the one labeled P11 is the active layer pattern of the eleventh transistor M11, the one labeled P12 is the active layer pattern of the twelfth transistor M12, the one labeled P13 is the active layer pattern of the thirteenth transistor M13, the one labeled is P14 is the active layer pattern of the fourteenth transistor M14, the one labeled P15 is the active layer pattern of the fifteenth transistor M15, the one labeled P16 is the active layer pattern of the sixteenth transistor M16, and the one labeled P17 is the active layer pattern of the seventeenth transistor M17, and the one labeled P18 is the active layer pattern of the eighteenth transistor M18.

In FIG. 13, the one labeled CO1b is the second electrode plate of CO1, the one labeled CO2b is the first electrode plate of CO2, the one labeled CO3b is the second electrode plate of CO3, and the one labeled CO4b is the second electrode plate of CO4. The one labeled C1b is the second electrode plate of C1.

As shown in FIG. 10-FIG. 13, GND, DR, DG, STV, CLK1, CLK3, TRST, VGL1, LVGL, VGH, VDDo, VDDe, VGL2, HC1, HC2, HC3 and HC4 all extend vertically;
GND, DR, DG, STV, CLK1, CLK3, TRST, VGL1, LVGL, VGH, VDDo and VDDe are all set on the side of the transistors included in the driving circuit away from the display area, and VGL2, HC1, HC2, HC3 and HC4 are all set on the side of the transistor included in the driving circuit close to the display area.

As shown in FIGS. 10 to 13, PO11, PO12, PO21, PO22, PO31, PO32, PO41 and PO42 all extend in the vertical direction;
PO11, PO21, PO31 and PO41 are arranged in sequence in the vertical direction;
PO21, PO22, PO32 and PO42 are arranged in sequence along the vertical direction;
PD11, PD12, PD21, PD22, PD31, PD32, PD41 and PD42 all extend in the vertical direction;
PD11, PD12, PD21, PD22, PD31, PD32, PD41 and PD42 are arranged in sequence in the vertical direction;
CO1a, CO2a, CO3a and CO4a are arranged in sequence along the vertical direction;
PV1, PV2, PV3 and PV4 extend along the vertical direction, and PV1, PV2, PV3 and PV4 are arranged in sequence along the vertical direction;
P1, P2, P3, P4, P5, P6, P7, P8, P9, P10, P11, P12, P13, P14, P15, P16, P17 and P18 all extend in the vertical direction.

When the layout shown in FIG. 10-FIG. 13 is applied to TPC (tablet computer) products, the width of the frame occupied by the driving circuit can be reduced by 0.1 mm-0.5 mm compared to the width of the frame occupied by the related driving circuit;
When the layout shown in FIG. 10-FIG. 13 is applied to NB (notebook computer) products, the width of the frame occupied by the driving circuit can be reduced by 0.1 mm-0.5 mm compared to the width of the frame occupied by the related driving circuit;
When the layout shown in FIGS. 10-13 is applied to TV products, the width of the frame occupied by the driving circuit can be reduced by 0.2 mm-0.8 mm compared to the width of the frame occupied by the related driving circuit; which facilitates narrow borders.

In at least one embodiment shown in FIGS. 10 to 13, the active layer of the transistor extends vertically, and the transistors are arranged vertically. The active layers are dispersed, which is beneficial to heat dissipation of the active layer.

Moreover, in at least one embodiment of the present disclosure, the layout of the active layers of different units is selected. Each transistor selects an appropriate unit according to its respective size. The unit of the active layer of each transistor ranges from 5 μm to 25 μm;
The unit of the active layer of a transistor is Sum, which means: the width of each channel portion of the active layer of the transistor is 5 μm;
The unit of the active layer of a transistor is 10 μm means: the width of each channel portion of the active layer of the transistor is 10 μm;
The unit of the active layer of a transistor is 25 μm, which means that the width of each channel portion of the active layer of the transistor is 25 μm.

It should be noted that the ratio of the channel width-to-length ratio of M6 to the channel width-to-length ratio of M7, and the ratio of the channel width-to-length ratio of M8 to the channel width-to-length ratio of M9 will affect the waveform of the potential of the PU, M6 and M7 are preferably designed to keep the same unit, and M8 and M9 are preferably designed to keep the same unit, for example, one unit equals Sum; if M6 and M7 use different units, M8 and M9 use different units, the ratio between the channel width-to-length ratio of M7 to the channel width-to-length ratio of M6 is greater than or equal to 6, and the ratio of the channel width-to-length ratio of M9 to the channel width-to-length ratio of M8 is greater than or equal to 6.

As shown in FIG. 12B, the width of P1 in the horizontal direction is W1, and W1 is equal to 5 μm;
The width of P4 in the horizontal direction is W4, and W4 is equal to 10 μm;
The width of PO11 in the horizontal direction is WO11, and WO11 is equal to 25 μm;
The width of P15 in the horizontal direction is W15, and W15 is equal to 20 μm;
The width of PV1 in the horizontal direction is WV1, and WV1 is equal to 7 μm;
The width of P10 in the horizontal direction, the width of P6 in the horizontal direction, the width of P7 in the horizontal direction, the width of P11 in the horizontal direction, the width of P8 in the horizontal direction, the width of P9 in the horizontal direction, the width of P3 in the horizontal direction, the width of P13 in the horizontal direction, the width of P14 in the horizontal direction, the width of P17 in the horizontal direction, the width of P17 in the horizontal direction can be 5 μm;
The width of PV2 in the horizontal direction, the width of PV3 in the horizontal direction, and the width of PV4 in the horizontal direction can all be 7 μm;
The width of P5 in the horizontal direction may be 10 μm
The width of PO12 in the horizontal direction, the width of PO21 in the horizontal direction, the width of PO22 in the horizontal direction, the width of PO31 in the horizontal direction, the width of PO32 in the horizontal direction, the width of PO41 in the horizontal direction, and the width of PO42 in the horizontal direction can be 25 μm;
The width of PD11 in the horizontal direction, the width of PD12 in the horizontal direction, the width of PD21 in the horizontal direction, the width of PD22 in the horizontal direction, the width of PD31 in the horizontal direction, the width of PD32 in the horizontal direction, the width of PD41 in the horizontal direction and the width of the PD42 in the horizontal direction may be 5 μm.

In at least one embodiment shown in FIGS. 12A and 12B, the length of P6 in the vertical direction is 10 μm, and the width of P6 in the horizontal direction is 5 μm;
The length of P10 in the vertical direction is 35 μm, and the width of P10 in the horizontal direction is 5 μm;
The length of P4 in the vertical direction is 250 μm, and the width of P4 in the horizontal direction is 10 μm;
The length of P1 in the vertical direction is 540 μm, and the width of P1 in the horizontal direction is 5 μm;
The length of PD11 in the vertical direction is 72 μm, and the width of PD11 in the horizontal direction is 5 μm;
The length of PV1 in the vertical direction is 180 μm, and the width of PD11 in the horizontal direction is 7 μm;
The length of P12 in the vertical direction is 360 μm, and the width of P12 in the horizontal direction is 10 μm;
The length of P15 in the vertical direction is 450 μm, and the width of P15 in the horizontal direction is 20 μm;
The length of P3 in the vertical direction is 35 μm, and the width of P1 in the horizontal direction is 5 μm;
The length of P13 in the vertical direction is 20 μm, and the width of P13 in the horizontal direction is 5 μm;
The length of P16 in the vertical direction is 75 μm, and the width of P16 in the horizontal direction is 5 μm;
The length of P2 in the vertical direction is 90 μm, and the width of P1 in the horizontal direction is 5 μm;
The length of P18 in the vertical direction is 40 μm, and the width of P18 in the horizontal direction is 5 μm;
The length of P8 in the vertical direction is the same as the length of P6 in the vertical direction, and the width of P8 in the horizontal direction is the same as the width of P6 in the horizontal direction;
The length of P7 along the vertical direction, the length of P9 along the vertical direction, the length of P17 along the vertical direction are equal to the length of P16 along the vertical direction;
The width of P7 in the horizontal direction, the width of P9 in the horizontal direction, the width of P17 in the horizontal direction are equal to the width of P16 in the horizontal direction;
The length of P5 in the vertical direction is the same as the length of P4 in the vertical direction, and the width of P5 in the horizontal direction is the same as the width of P4 in the horizontal direction;
The length of PV2 in the vertical direction, the length of PV3 in the vertical direction, and the length of PV4 in the vertical direction are equal to the length of PV1 in the vertical direction;
The width of PV2 in the horizontal direction, the width of PV3 in the horizontal direction, the width of PV4 in the horizontal direction are equal to the width of PV1 in the horizontal direction;
The length of PO12 in the vertical direction, the length of PO21 in the vertical direction, the length of PO22 in the vertical direction, the length of PO31 in the vertical direction, the length of PO32 in the vertical direction, the length of PO41 in the vertical direction, the length of PO42 in the vertical direction are equal to the length of POLI in the vertical direction;
The width of PO12 in the horizontal direction, the width of PO21 in the horizontal direction, the width of PO22 in the horizontal direction, the width of PO31 in the horizontal direction, the width of PO32 in the horizontal direction, the width of PO41 in the horizontal direction, the width of PO42 in the horizontal direction are equal to the width of PO11 in the horizontal direction;
The length of PD12 in the vertical direction, the length of PD21 in the vertical direction, the length of PD22 in the vertical direction, the length of PD31 in the vertical direction, the length of PD32 in the vertical direction, the length of PD41 in the vertical direction, the length of PD42 in the vertical direction are equal to the length of PD11 in the vertical direction;
The width of PD12 in the horizontal direction, the width of PD21 in the horizontal direction, the width of PD22 in the horizontal direction, the width of PD31 in the horizontal direction, the width of PD32 in the horizontal direction, the width of PD41 in the horizontal direction, the width of PD42 in the horizontal direction are equal to the width of PO11 in the horizontal direction.

In at least one embodiment of the present disclosure, the ratio of the length of P6 in the vertical direction to the width of P6 in the horizontal direction may be greater than or equal to 1 and less than or equal to 3;
The ratio of the vertical length of P10 to the horizontal width of P6 may be greater than or equal to 5 and less than or equal to 10;
The ratio of the length of P4 in the vertical direction to the width of P5 in the horizontal direction may be greater than or equal to 18 and less than or equal to 32;
The ratio of the length of P1 in the vertical direction to the width of P6 in the horizontal direction may be greater than or equal to 80 and less than or equal to 130;
The ratio of the length of PO11 in the vertical direction to the width of P6 in the horizontal direction may be greater than or equal to 3 and less than or equal to 10;
The ratio of the length of PD11 in the vertical direction to the width of PD11 in the horizontal direction may be greater than or equal to 8 and less than or equal to 25;
The ratio of the length of PV1 in the vertical direction to the width of PV1 in the horizontal direction may be greater than or equal to 15 and less than or equal to 35;
The ratio of the length of P12 in the vertical direction to the width of P12 in the horizontal direction may be greater than or equal to 25 and less than or equal to 50;
The ratio of the length of P15 in the vertical direction to the width of P6 in the horizontal direction may be greater than or equal to 16 and less than or equal to 40;
The ratio of the length of P3 in the vertical direction to the width of P6 in the horizontal direction may be greater than or equal to 4 and less than or equal to 12;
The ratio of the length of P13 in the vertical direction to the width of P6 in the horizontal direction may be greater than or equal to 2 and less than or equal to 8;
The ratio of the length of P16 in the vertical direction to the width of P6 in the horizontal direction may be greater than or equal to 8 and less than or equal to 25;
The ratio of the length of P2 in the vertical direction to the width of P6 in the horizontal direction may be greater than or equal to 10 and less than or equal to 25;
The ratio of the length of P18 in the vertical direction to the width of P18 in the horizontal direction may be greater than or equal to 4 and less than or equal to 16;
But it is not limited to this.

In at least one embodiment of the present disclosure, in order to achieve a narrow frame, the active layer pattern of each transistor is designed in a vertically long and narrow strip shape, which facilitates layout.

In at least one embodiment of the present disclosure, the length-to-width ratio of the active layer pattern of the tenth transistor is greater than or equal to 5 and less than or equal to 10;
The length-to-width ratio of the active layer pattern of the fourth transistor and the length-to-width ratio of the active layer pattern of the fifth transistor are greater than and equal to 18 and less than or equal to 32;
The length-to-width ratio of the active layer pattern of the fifteenth transistor is greater than or equal to 16 and less than or equal to 40;
The length-to-width ratio of the active layer pattern of the twelfth transistor is greater than or equal to 25 and less than or equal to 50;
The length-to-width ratio of the active layer pattern of the first transistor is greater than or equal to 80 and less than or equal to 130;
The length-to-width ratio is a ratio between the length of the active layer pattern along the first direction and the width of the active layer pattern along the second direction.

Optionally, the first direction may be a vertical direction, and the second direction may be a horizontal direction.

In FIGS. 10, 11A, 11B, 12A, 12B, 13, 19, 20A, 20B, 21 and 22, Y indicates the first direction and X indicates the second direction.

In at least one embodiment of the present disclosure, the width of the active layer pattern of each transistor in the horizontal direction is greater than or equal to 3 μm, so that there is no risk of breakage during process fluctuations;
The active layer pattern of each transistor is greater than or equal to 10 μm, and the length in the vertical direction and the width in the horizontal direction of the active layer patterns of different transistors can be adjusted.

In at least one embodiment of the present disclosure, the driving circuit may include a driving control signal generation circuit; the driving control signal generation circuit may include a first capacitor;
The electrode plate of the first capacitor includes a first electrode plate portion and a second electrode plate portion that are connected to each other; the first electrode plate portion is in the shape of a block;
The second electrode plate portion extends along the first direction;
The ratio of the length of the second electrode plate portion along the first direction to the width of the second electrode plate portion along the second direction is greater than or equal to 6 and less than or equal to 25.

In specific implementation, the electrode plates of the first capacitor may be the first electrode plate and/or the second electrode plate. In the following description, the electrode plate is the first electrode plate as an example.

As shown in FIG. 11C, the first electrode plate of the first capacitor includes a first electrode plate portion C1a1 and a second electrode plate portion C1a2 that are connected to each other;
C1a1 is in the shape of a block, and C1a2 extends in the vertical direction;
The length of C1a2 along the vertical direction may be 467 μm, and the width of C1a2 along the horizontal direction may be 35 μm;
The length of C1a1 along the vertical direction may be 123 μm, and the width of C1a1 along the horizontal direction may be 85 μm;
But it is not limited to this.

In specific implementation, the ratio of the length of the second electrode plate portion C1a2 in the vertical direction to the width of the second electrode plate portion C1a2 in the horizontal direction may be greater than or equal to 6 and less than or equal to 25.

In actual operation, since the active layer patterns of the transistors around the first capacitor are long strips extending in the vertical direction, and for the convenience of layout, the first electrode plate of the first capacitor may include the second electrode plate portion extending in the vertical direction.

Optionally, the driving circuit includes a driving control signal generation circuit and a multi-channel output circuit; the driving control signal generation circuit includes a first capacitor and a fifteenth transistor; the multi-channel output circuit includes an output sub-circuit; the output sub-circuit includes an on-off control transistor;
The first capacitor is arranged between the fifteenth transistor and the on-off control transistor.

In at least one embodiment shown in FIGS. 10 to 14, the first capacitor C1 may be arranged among the fifteenth transistor M15, the first on-off control transistor MV1, the second on-off control transistor MV2 and the third on-off control transistor MV3.

In at least one embodiment shown in FIGS. 10 to 14, HC1, HC2, HC3 and HC4 are arranged on the side of each transistor included in the driving circuit close to the display area, which is beneficial to reducing the crossover distance and saving space;
The distance in the horizontal direction between the orthographic projection of VDDe on the base substrate and the orthographic projection of P7 on the base substrate is 60 um, which is helpful to prevent the ESD of the wiring from damaging the transistor.

FIG. 14 is a top plan view of the second ITO (indium tin oxide) layer in FIG. 10. Each component in the driving circuit can be coupled to each other through conductive patterns provided on the second ITO layer.

In at least one embodiment shown in FIG. 10, along the direction away from the base substrate, a gate metal layer, a semiconductor layer, a source-drain metal layer and a second ITO layer are sequentially provided;
An organic film layer and a passivation layer are provided between the source-drain metal layers and the second ITO layer. Via holes are provided on the organic film layer and the passivation layer, and each component in the driving circuit can be coupled to each conductive pattern provided on the second ITO layer through the via holes.

In at least one embodiment of the present disclosure, the channel width-to-length ratio of M1 may be greater than or equal to 12 and less than or equal to 15, and the channel width-to-length ratio of M2 may be greater than or equal to 2 and less than or equal to 5,
The channel width-to-length ratio of M15 can be greater than or equal to 100 and less than or equal to 200, and the channel width-to-length ratio of M18 can be greater than or equal to 4 and less than or equal to 6.

The channel width-to-length ratio of M6 can be greater than or equal to 0.8 and less than or equal to 1.2, and the channel width-to-length ratio of M7 can be greater than or equal to 4 and less than or equal to 4.8.

The channel width-to-length ratio of M11 can be greater than or equal to 3 and less than or equal to 5, and the channel width-to-length ratio of M5 can be greater than or equal to 13 and less than or equal to 15.

The channel width-to-length ratio of M12 can be greater than or equal to 70 and less than or equal to 90. The channel width-to-length ratio of M13 and M14 can be greater than or equal to 1 and less than or equal to 3. The channel width-to-length ratio of M16 and M17 can be greater than or equal to 7 and less than or equal to 9,
The channel width-to-length ratio of MV1, the channel width-to-length ratio of MV2, the channel width-to-length ratio of MV3, and the channel width-to-length ratio of MV4 can be greater than or equal to 40 and less than or equal to 80;
The channel width-to-length ratio of MO1, the channel width-to-length ratio of MO2, the channel width-to-length ratio of MO3, and the channel width-to-length ratio of MO4 can be greater than or equal to 100 and less than or equal to 200;
The channel width-to-length ratio of MD11, the channel width-to-length ratio of MD12, the channel width-to-length ratio of MD21, the channel width-to-length ratio of MD22, the channel width-to-length ratio of MD31, the channel width-to-length ratio of MD32, the channel width-to-length ratio of MD41 and the channel width-to-length ratio of MD42 can be greater than or equal to 7 and less than or equal to 9;
The capacitance value of C1 can be greater than or equal to 1 pF and less than or equal to 3 pF;
The capacitance value of CO1, the capacitance value of CO2, the capacitance value of CO3 and the capacitance value of CO2 can be greater than or equal to 1 pF and less than or equal to 3 pF;
But it is not limited to this.

In at least one embodiment of the present disclosure, the display substrate includes a peripheral area and a display area; the driving circuit includes a driving control signal generation circuit and a multi-channel output circuit;
The driving control signal generation circuit is arranged in the peripheral area;
The multi-channel output circuit includes N output sub-circuits, and the nth output sub-circuit includes an nth output transistor; N is an integer greater than 1, and n is a positive integer less than or equal to N;
The nth output transistor is arranged in the display area.

In specific implementation, the driving control signal generation circuit can be arranged in the peripheral area, and the multi-channel output circuit can be arranged in the display area; the nth output transistor included in the multi-channel output circuit can be arranged next to the thin film transistor included in the pixel circuit, the gate electrode of the nth output transistor is electrically connected to the driving control signal output terminal, the drain electrode of the nth output transistor is electrically connected to the output clock signal line, and the source electrode of the nth output transistor is electrically connected to the driving signal output terminal.

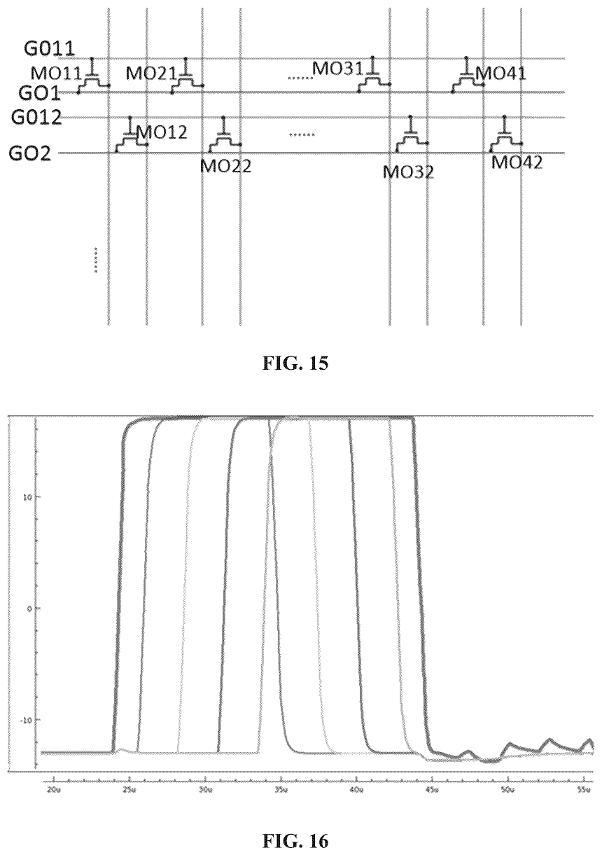

As shown in FIG. 15, the one labeled MO11 is the first first output transistor, the one labeled MO12 is the first second output transistor, the one labeled MO21 is the second first output transistor, and the one labeled MO22 is the second second output transistor, the one labeled MO31 is the third first output transistor, the one labeled MO32 is the third second output transistor, the one labeled MO41 is the fourth first output transistor, the one labeled MO42 is the fourth second output transistor;
The gate electrode of MO11 is electrically connected to the first driving control signal output terminal G011, the drain electrode of MO11 is electrically connected to the first first output clock signal line HC11, and the source electrode of MO11 is electrically connected to the first driving signal output terminal GO1;
The gate electrode of MO12 is electrically connected to the second driving control signal output terminal G012, the drain electrode of MO12 is electrically connected to the first second output clock signal line HC12, and the source electrode of MO12 is electrically connected to the second driving signal output terminal GO2;
The gate electrode of MO21 is electrically connected to the first driving control signal output terminal G011, the drain electrode of MO21 is electrically connected to the second first output clock signal line HC21, and the source electrode of MO21 is electrically connected to the first driving signal output terminal GO1;
The gate electrode of MO22 is electrically connected to the second driving control signal output terminal G012, the drain electrode of MO22 is electrically connected to the second second output clock signal line HC22, and the source electrode of MO22 is electrically connected to the second driving signal output terminal GO2;
The gate electrode of MO31 is electrically connected to the first driving control signal output terminal G011, the drain electrode of MO31 is electrically connected to the third first output clock signal line HC31, and the source electrode of MO31 is electrically connected to the first driving signal output terminal GO1;
The gate electrode of MO32 is electrically connected to the second driving control signal output terminal G012, the drain electrode of MO32 is electrically connected to the third second output clock signal line HC32, and the source electrode of MO32 is electrically connected to the second driving signal output terminal GO2;
The gate electrode of MO41 is electrically connected to the first driving control signal output terminal G011, the drain electrode of MO41 is electrically connected to the fourth first output clock signal line HC41, and the source electrode of MO41 is electrically connected to the first driving signal output terminal GO1;
The gate electrode of MO42 is electrically connected to the second driving control signal output terminal G012, the drain electrode of MO42 is electrically connected to the fourth second output clock signal line HC42, and the source electrode of MO42 is electrically connected to the second driving signal output terminal GO2.

In at least one embodiment shown in FIG. 15, each output transistor is an n-type transistor, but is not limited to this.

For example, when the display device is a display screen with a resolution of 1600×2560 and there are 1600 pixel circuits in the horizontal direction,
In one case, each pixel circuit is connected to one output clock signal line, and one output transistor is placed next to each pixel circuit. A driving control signal output terminal can connect 1600 output transistors. After simulating, the channel width-to-length ratio of each output transistor is about 1000/5;
In another case, one output transistor can be set for every 8 pixel circuits, and 200 output transistors can be connected to one driving control signal output terminal;
But it is not limited to this.

It should be noted that the design of setting output transistors in the display area will affect the aperture ratio and reduce the aperture ratio by about 10%. This design is suitable for displays that require extremely narrow borders but do not require extreme brightness.

In addition, it was found through simulation that M16 and M17 continuously reduce noise on the driving control signal output terminal, and the size of the output transistor is small, and the output clock signal has a small impact on the coupling of the driving control signal output terminal through the parasitic capacitance of the output transistor, the noise of the driving control signal is very small, and the noise of the driving signal provided by the corresponding driving signal output terminal will also be very small. Therefore, in order to pursue the extremely narrow frame design, MD11, MD12, MD21, MD22, MD31, MD32, MD41 and MD42 can be removed.

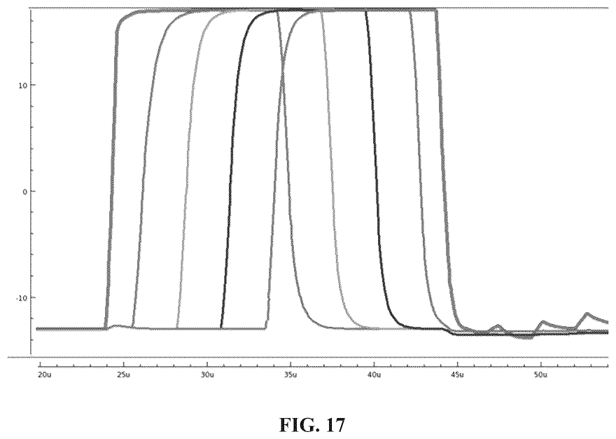

After simulation, when each output pull-down transistor is removed, the driving circuit can normally output the corresponding driving signal. FIG. 16 is the waveform of each driving signal output by the driving circuit in the initial state when each output pull-down transistor is removed. FIG. 17 is the waveform of each driving signal output by the driving circuit after each output pull-down transistor is removed and after the driving circuit is at 60 degrees Celsius for 1000 hours.

In specific implementation, the multi-channel output circuit also includes N output clock signal lines;
The output clock signal line is arranged in the display area, thereby further achieving a narrow frame.

Optionally, the nth output sub-circuit further includes an nth on-off control transistor and an nth output capacitor; the nth on-off control transistor and the nth output capacitor are both arranged in the peripheral area;
The active layer pattern of the nth on-off control transistor extends along the first direction;
The active layer patterns of the on-off control transistors respectively included in the N output sub-circuits are arranged along the first direction;
The output capacitors respectively included in the N output sub-circuits are arranged along the first direction.

In specific implementation, the active layer patterns of each on-off control transistor extend along the first direction, the active layer patterns of the on-off control transistors included in the N output sub-circuits are arranged along the first direction, and the active layer patterns of the transistors are very dispersed, which is beneficial to the heat dissipation of the active layer.

In at least one embodiment of the present disclosure, the active layer pattern of the nth on-off control transistor extends along the first direction;
The active layer patterns of the on-off control transistors respectively included in the N output sub-circuits are arranged along the first direction;
The output capacitors respectively included in the N output sub-circuits are arranged along the first direction.

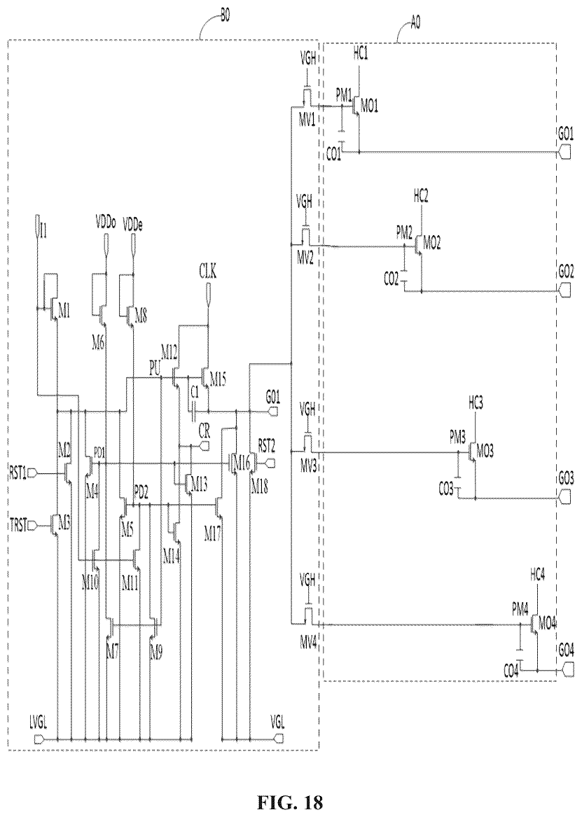

FIG. 18 is a circuit diagram of a driving circuit according to at least one embodiment of the present disclosure.

As shown in FIG. 18, based on at least one embodiment of the driving circuit shown in FIG. 3, the first output sub-circuit 11 may include a first output transistor MO1, a first on-off control transistor MV1 and a first output capacitor CO1;
The gate electrode of the first output transistor MO1 is electrically connected to the first pull-up control node PM1, and the drain electrode of the first output transistor MO1 is electrically connected to the first output clock signal line HC1. The source electrode of the first output transistor MO1 is electrically connected to the first driving signal output terminal GO1;
The gate electrode of the first output transistor MO1 is electrically connected to the driving control signal output terminal G01 through the first on-off control transistor MV1;
The gate electrode of the first on-off control transistor MV1 is electrically connected to the high voltage line VGH, and the drain electrode of the first on-off control transistor MV1 is electrically connected to the driving control signal output terminal G01. The source electrode of the first on-off control transistor MV1 is electrically connected to the gate electrode of the first output transistor MO1;
The first electrode plate of the first output capacitor CO1 is electrically connected to the gate electrode of the first output transistor MO1, and the second electrode plate of the first output capacitor CO1 is electrically connected to the source electrode of the first output transistor MO1;
The second output sub-circuit 12 may include a second output transistor MO2, a second on-off control transistor MV2 and a second output capacitor CO2;
The gate electrode of the second output transistor MO2 is electrically connected to the second pull-up control node PM2, and the drain electrode of the second output transistor MO2 is electrically connected to the second output clock signal line HC2. The source electrode of the second output transistor MO2 is electrically connected to the second driving signal output terminal GO2;
The gate electrode of the second output transistor MO2 is electrically connected to the driving control signal output terminal G01 through the second on-off control transistor MV2;
The gate electrode of the second on-off control transistor MV2 is electrically connected to the high voltage line VGH, and the drain electrode of the second on-off control transistor MV2 is electrically connected to the driving control signal output terminal G01. The source electrode of the second on-off control transistor MV2 is electrically connected to the gate electrode of the second output transistor MO2;
The first electrode plate of the second output capacitor CO2 is electrically connected to the gate electrode of the second output transistor MO2, and the second electrode plate of the second output capacitor CO2 is electrically connected to the source electrode of the second output transistor MO2;
The third output sub-circuit 13 may include a third output transistor MO3, a third on-off control transistor MV3 and a third output capacitor CO3;
The gate electrode of the third output transistor MO3 is electrically connected to the third pull-up control node PM3, and the drain electrode of the third output transistor MO3 is electrically connected to the third output clock signal line HC3. The source electrode of the third output transistor MO3 is electrically connected to the third driving signal output terminal GO3;
The gate electrode of the third output transistor MO3 is electrically connected to the driving control signal output terminal G01 through the third on-off control transistor MV3;
The gate electrode of the third on-off control transistor MV3 is electrically connected to the high voltage line VGH, and the drain electrode of the third on-off control transistor MV3 is electrically connected to the driving control signal output terminal G01. The source electrode of the third on-off control transistor MV3 is electrically connected to the gate electrode of the third output transistor MO3;
The first electrode plate of the third output capacitor CO3 is electrically connected to the gate electrode of the third output transistor MO3, and the second electrode plate of the third output capacitor CO3 is electrically connected to the source electrode of the third output transistor MO3;
The fourth output sub-circuit 14 may include a fourth output transistor MO4, a fourth on-off control transistor MV4 and a fourth output capacitor CO4;
The gate electrode of the fourth output transistor MO4 is electrically connected to the fourth pull-up control node PM4, and the drain electrode of the fourth output transistor MO4 is electrically connected to the fourth output clock signal line HC4. The source electrode of the fourth output transistor MO4 is electrically connected to the fourth driving signal output terminal GO4;
The gate electrode of the fourth output transistor MO4 is electrically connected to the driving control signal output terminal G01 through the fourth on-off control transistor MV4;
The gate electrode of the fourth on-off control transistor MV4 is electrically connected to the high voltage line VGH, and the drain electrode of the fourth on-off control transistor MV4 is electrically connected to the driving control signal output terminal G01. The source electrode of the fourth on-off control transistor MV4 is electrically connected to the gate electrode of the fourth output transistor MO4;
The first electrode plate of the fourth output capacitor CO4 is electrically connected to the gate electrode of the fourth output transistor MO4, and the second electrode plate of the fourth output capacitor CO4 is electrically connected to the source electrode of the fourth output transistor MO4;
The pull-up node control circuit 31 includes a first transistor M1, a second transistor M2, a third transistor M3, a fourth transistor M4 and a fifth transistor M5;
The gate electrode of the first transistor M1 and the drain electrode of the first transistor M1 are electrically connected to the input terminal I1, and the source electrode of the first transistor M1 is electrically connected to the pull-up node PU;
The source electrode of the second transistor M2 is electrically connected to the first reset terminal RST1, the drain electrode of the second transistor M2 is electrically connected to the pull-up node PU, and the source electrode of the second transistor M2 is electrically connected to the second low voltage line LVGL;
The gate electrode of the third transistor M3 is electrically connected to the frame reset terminal TRST, the drain electrode of the third transistor M3 is electrically connected to the pull-up node PU, and the source electrode of the third transistor M3 is electrically connected to the second low voltage line LVGL;
The gate electrode of the fourth transistor M4 is electrically connected to the first pull-down node PD1, the drain electrode of the fourth transistor M4 is electrically connected to the pull-up node PU, and the source electrode of the fourth transistor M4 is electrically connected to the second low voltage line LVGL;
The gate electrode of the fifth transistor M5 is electrically connected to the second pull-down node PD2, the drain electrode of the fifth transistor M5 is electrically connected to the pull-up node PU, and the source electrode of the fifth transistor M5 is electrically connected to the second low voltage line LVGL;
The first pull-down node control circuit 32 includes a sixth transistor M6 and a seventh transistor M7;
The gate electrode of the sixth transistor M6 and the drain electrode of the sixth transistor M6 are electrically connected to the first control voltage line VDDo, and the source electrode of the sixth transistor M6 is electrically connected to the first pull-down node PD1;
The gate electrode of the seventh transistor M7 is electrically connected to the pull-up node PU, the drain electrode of the seventh transistor M7 is electrically connected to the first pull-down node PD1, and the source electrode of the seventh transistor M7 is electrically connected to the second low voltage line LVGL;
The second pull-down node control circuit 33 includes an eighth transistor M8 and a ninth transistor M9;
The gate electrode of the eighth transistor M8 and the drain electrode of the eighth transistor M8 are electrically connected to the second control voltage line VDDe, and the source electrode of the eighth transistor M8 is electrically connected to the second pull-down node PD2;
The gate electrode of the ninth transistor M9 is electrically connected to the pull-up node PU, the drain electrode of the ninth transistor M9 is electrically connected to the second pull-down node PD2, and the source electrode of the ninth transistor M9 is electrically connected to the second low voltage line LVGL;
The first pull-down node control circuit 32 further includes a tenth transistor M10, and the second pull-down node control circuit 33 further includes an eleventh transistor M11;
The gate electrode of the tenth transistor M10 is electrically connected to the input terminal I1, the drain electrode of the tenth transistor M10 is electrically connected to the first pull-down node PD1, and the source electrode of the tenth transistor M10 is electrically connected to the second low voltage line LVGL;
The gate electrode of the eleventh transistor M11 is electrically connected to the input terminal I1, the drain electrode of the eleventh transistor M11 is electrically connected to the second pull-down node PD2, and the source electrode of the eleventh transistor M11 is electrically connected to the second voltage line LVGL;
The carry output circuit 35 includes a twelfth transistor M12, a thirteenth transistor M13, and a fourteenth transistor M14;
The gate electrode of the twelfth transistor M12 is electrically connected to the pull-up node PU, and the drain electrode of the twelfth transistor M12 is electrically connected to the driving control clock signal line CLK. The source electrode of the twelfth transistor M12 is electrically connected to the carry output terminal CR;
The gate electrode of the thirteenth transistor M13 is electrically connected to the first pull-down node PD1, and the drain electrode of the thirteenth transistor M13 is electrically connected to the carry output terminal CR the source electrode of the thirteenth transistor M13 is electrically connected to the second low voltage line LVGL;
The gate electrode of the fourteenth transistor M14 is electrically connected to the second pull-down node PD2, the drain electrode of the fourteenth transistor M14 is electrically connected to the carry output terminal CR, and the source electrode of the fourteenth transistor M14 is electrically connected to the second low voltage line LVGL;
The driving control output circuit 34 includes a fifteenth transistor M15, a sixteenth transistor M16, a seventeenth transistor M17, an eighteenth transistor M18 and a first capacitor C1;
The gate electrode of the fifteenth transistor M15 is electrically connected to the pull-up node PU, and the drain electrode of the fifteenth transistor M15 is electrically connected to the driving control clock signal line CLK. The source electrode of the fifteenth transistor M15 is electrically connected to the driving control signal output terminal G01;
The gate electrode of the sixteenth transistor M16 is electrically connected to the first pull-down node PD1, and the drain electrode of the sixteenth transistor M16 is electrically connected to the driving control signal output terminal G01. The source electrode of the sixteenth transistor M16 is electrically connected to the first low voltage line VGL;
The gate electrode of the seventeenth transistor M17 is electrically connected to the second pull-down node PD2, and the drain electrode of the seventeenth transistor M17 is electrically connected to the driving control signal output terminal G01. The source electrode of the seventeenth transistor M17 is electrically connected to the first low voltage line VGL;
The gate electrode of the eighteenth transistor M18 is electrically connected to the second reset terminal RST2, and the drain electrode of the eighteenth transistor M18 is electrically connected to the driving control signal output terminal G01. The source electrode of the eighteenth transistor M18 is electrically connected to the first low voltage line VGL;
The first electrode plate of the first capacitor C1 is electrically connected to the pull-up node PU, and the second electrode plate of the first capacitor C1 is electrically connected to the driving control signal output terminal G01.

In at least one embodiment of the driving circuit shown in FIG. 18, MO1, MO2, MO3 and MO4 are arranged in the display area A0, and other transistors and capacitors are arranged in the peripheral area B0.

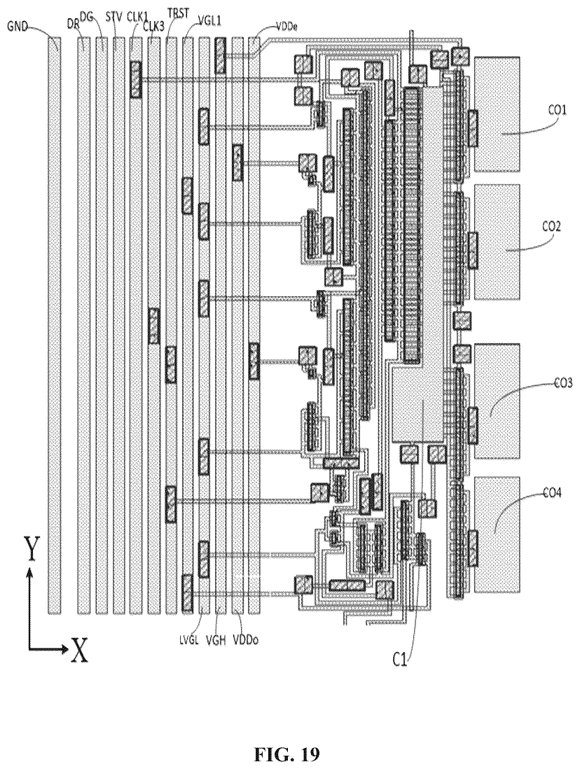

FIG. 19 is a top plan view of parts of the driving circuit shown in FIG. 18 other than MO1, MO2, MO3, and MO4.

In FIG. 19 and FIG. 20A, the one labeled GND is the ground, the one labeled DR is the first peripheral test line, the one labeled DG is the second peripheral test line, the one labeled STV is the start signal line, and the one labeled CLK1 is the first driving control clock signal line, the one labeled TRST is the frame reset line, the one labeled VGL1 is the first first low voltage line, the one labeled LVGL is the second low voltage line, and the one labeled VGH is the high voltage line, the one labeled VDDo is the first control voltage line, and the one labeled VDDe is the second control voltage line;
In FIG. 19, the one labeled CO1 is the first output capacitor, the one labeled CO2 is the second output capacitor, the one labeled CO3 is the third output capacitor, and the one labeled CO4 is the fourth output capacitor;
The one labeled C1 is the first capacitor.

FIGS. 20A and 20B are plan top views of the gate metal layer in FIG. 19.

In FIG. 20A, GV1 is the gate electrode of the first on-off control transistor MV1,
GV2 is the gate electrode of the second on-off control transistor MV2, and GV3 is the gate electrode of the third on-off control transistor MV3. GV4 is the gate electrode of the fourth on-off control transistor MV4;
G1 is the gate electrode of the first transistor M1, G2 is the gate electrode of the second transistor M2, G3 is the gate electrode of the third transistor M3, and G4 is the gate electrode of the fourth transistor M4. The one labeled G5 is the gate electrode of the fifth transistor M5, the one labeled G6 is the gate electrode of the sixth transistor M6, the one labeled G7 is the gate electrode of the seventh transistor M7, and the one labeled G8 is the gate electrode of the eighth transistor M8. The one labeled G9 is the gate electrode of the ninth transistor M9, the one labeled G10 is the gate electrode of the tenth transistor M10, the one labeled G11 is the gate electrode of the eleventh transistor M11, and the one labeled G12 is the gate electrode of the twelfth transistor M12, the one labeled G13 is the gate electrode of the thirteenth transistor M13, the one labeled G14 is the gate electrode of the fourteenth transistor M14, the one labeled G15 is the gate electrode of the fifteenth transistor M15, The one labeled G16 is the gate electrode of the sixteenth transistor M16, the one labeled G17 is the gate electrode of the seventeenth transistor M17, and the one labeled G18 is the gate electrode of the eighteenth transistor M18.

In FIG. 20A, the one labeled CO1a is the first electrode plate of CO1, the one labeled CO2a is the first electrode plate of CO2, the one labeled CO3a is the first electrode plate of CO3, and the one labeled CO4a is the first electrode plate of CO4. The one labeled C1a is the first electrode plate of C1.

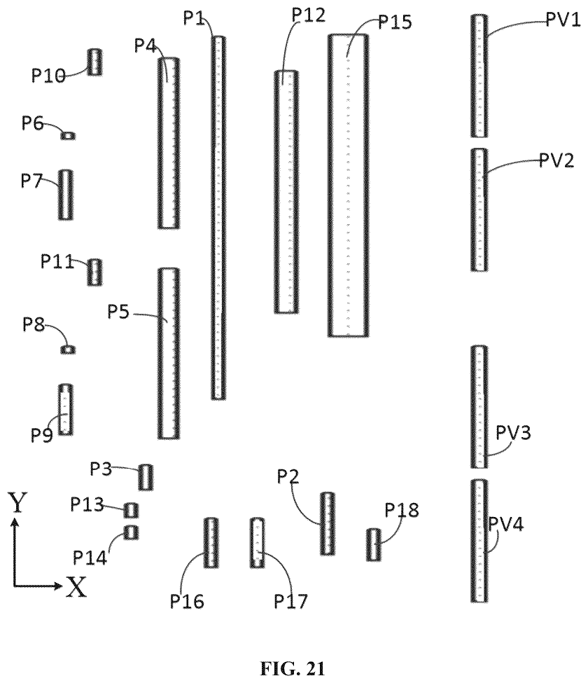

FIG. 21 is a top plan view of the semiconductor layer in FIG. 20A.

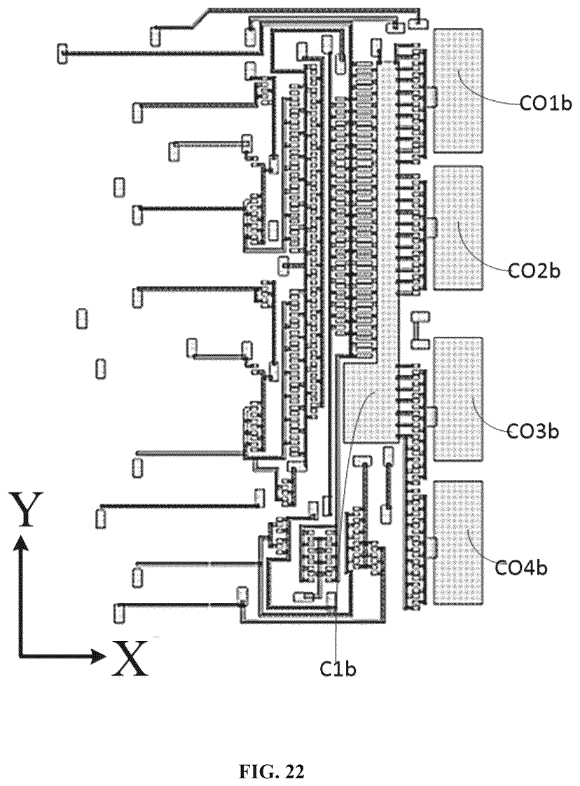

FIG. 22 is a top plan view of the source-drain metal layer in FIG. 20A.

In FIG. 21, the one labeled PV1 is the active layer pattern of the first on-off control transistor MV1, the one labeled PV2 is the active layer pattern of the second on-off control transistor MV2, the one labeled PV3 is the active layer pattern of the third on-off control transistor MV3, the one labeled PV4 is the active layer pattern of the fourth on-off control transistor MV4;
The one labeled P1 is the active layer pattern of the first transistor M1, the one labeled P2 is the active layer pattern of the second transistor M2, the one labeled P3 is the active layer pattern of the third transistor M3, the one labeled P4 is the active layer pattern of the fourth transistor M4, the one labeled P5 is the active layer pattern of the fifth transistor M5, the one labeled P6 is the active layer pattern of the sixth transistor M6, the one labeled P7 is the active layer pattern of the seventh transistor M7. The one labeled P8 is the active layer pattern of the eighth transistor M8, the one labeled P9 is the active layer pattern of the ninth transistor M9, the one labeled P10 is the active layer pattern of the tenth transistor M10, the one labeled P11 is the active layer pattern of the eleventh transistor M11, the one labeled P12 is the active layer pattern of the twelfth transistor M12, the one labeled P13 is the active layer pattern of the thirteenth transistor M13, the one labeled P14 is the active layer pattern of the fourteenth transistor M14, the one labeled P15 is the active layer pattern of the fifteenth transistor M15, the one labeled P16 is the active layer pattern of the sixteenth transistor M16, the one labeled P17 is the active layer pattern of the seventeenth transistor M17, and the one labeled P18 is the active layer pattern of the eighteenth transistor M18.

In FIG. 22, the one labeled CO1b is the second electrode plate of CO1, the one labeled CO2b is the first electrode plate of CO2, the one labeled CO3b is the second electrode plate of CO3, and the one labeled CO4b is the second electrode plate of CO4. The one labeled C1b is the second electrode plate of C1.

As shown in FIG. 19-FIG. 22, GND, DR, DG, STV, CLK1, CLK3, TRST, VGL1, LVGL, VGH, VDDo and VDDe all extend vertically;
GND, DR, DG, STV, CLK1, CLK3, TRST, VGL1, LVGL, VGH, VDDo and VDDe are all provided on the side of the transistor included in the driving circuit away from the display area.

As shown in FIGS. 19 to 22, CO1a, CO2a, CO3a and CO4a are arranged in sequence along the vertical direction;
PV1, PV2, PV3 and PV4 extend along the vertical direction, and PV1, PV2, PV3 and PV4 are arranged in sequence along the vertical direction;
P1, P2, P3, P4, P5, P6, P7, P8, P9, P10, P11, P12, P13, P14, P15, P16, P17 and P18 all extend in the vertical direction.

Using the layout of FIGS. 19 to 22, the width of the frame occupied by the driving circuit can be reduced by 0.4 mm compared to the width of the frame occupied by the existing driving circuit, which is conducive to realizing a narrow frame.

In at least one embodiment shown in FIGS. 19 to 22, the active layer of the transistor extends vertically, and the transistors are arranged vertically, and the active layer is dispersed, which is beneficial to heat dissipation of the active layer.

In at least one embodiment shown in FIGS. 19-22, the distance in the horizontal direction between the orthographic projection of VDDe on the base substrate and the orthographic projection of P7 on the base substrate is 60 um, which is beneficial to preventing ESD of lines from destroying transistors.

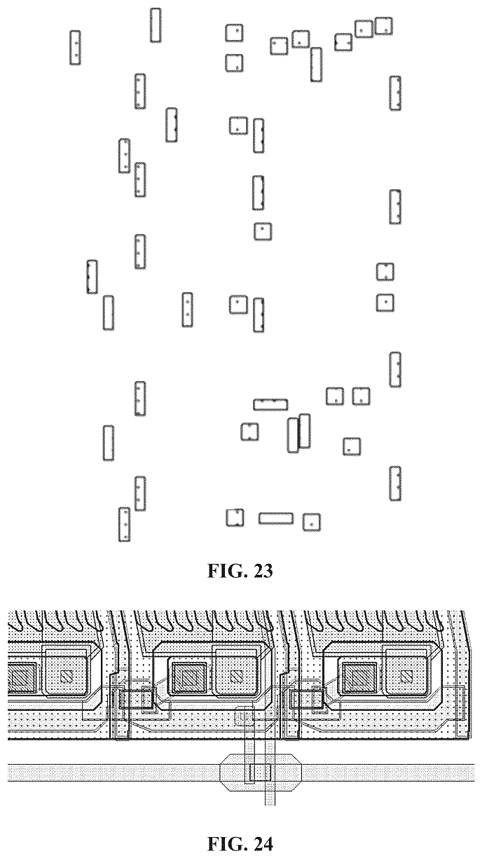

FIG. 23 is a top plan view of the second ITO (indium tin oxide) layer in FIG. 19. Each component in the driving circuit can be coupled to each other through conductive patterns provided on the second ITO layer.

In at least one embodiment shown in FIG. 19, along the direction away from the base substrate, a gate metal layer, a semiconductor layer, a source-drain metal layer and a second ITO layer are sequentially provided;
An organic film layer and a passivation layer are provided between the source-drain metal layer and the second ITO layer. Via holes are provided on the organic film layer and the passivation layer, and each component in the driving circuit can be coupled to each conductive pattern provided on the second ITO layer through the via holes.

FIG. 24 is a top plan view of the first output transistor provided in the display area.

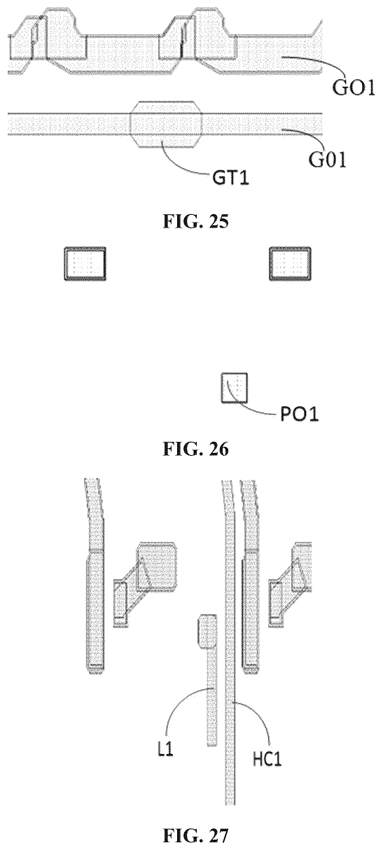

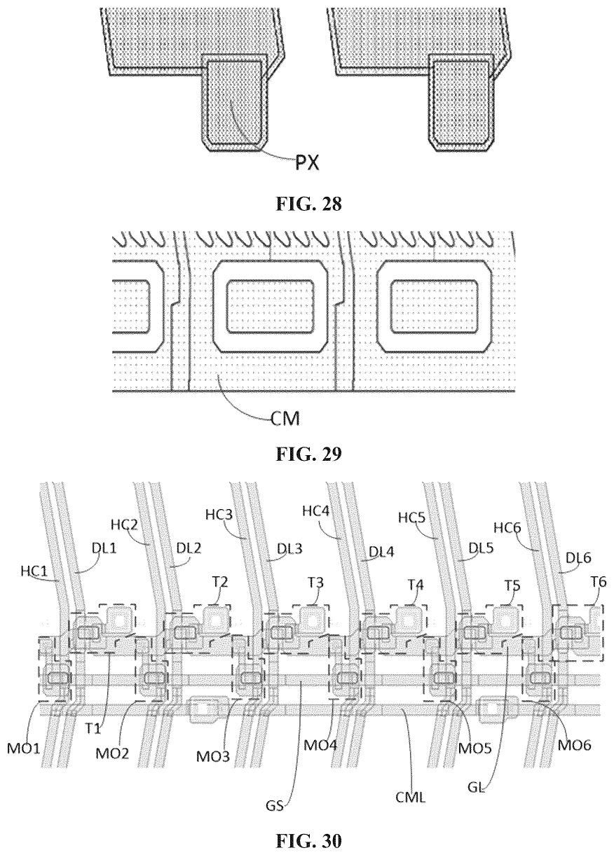

FIG. 25 is a top plan view of the gate metal layer in FIG. 24, FIG. 26 is a top plan view of the semiconductor layer in FIG. 24, FIG. 27 is a top plan view of the source-drain metal layer in FIG. 24, and FIG. 28 is a top plan view of the first ITO layer in FIG. 24. FIG. 29 is a top plan view of the second ITO layer in FIG. 24.

In FIG. 25, GT1 is the gate electrode of the first output transistor MO1, G01 is the driving control signal output terminal, and GO1 is the first driving signal output terminal.

In FIG. 26, the one labeled POI is the active layer pattern of MO1. The active layer pattern POI of MO1 includes the source electrode of MO1, the channel portion of MO1, and the drain electrode of MO1, which are arranged in sequence from left to right.

In FIG. 27, the one labeled L1 is the first conductive connection portion, and the one labeled HC1 is the first output clock signal line. The first conductive connection portion L1 is configured to electrically connect the source electrode of MO1 and the first driving signal output terminal GO1.

In FIG. 28, the one labeled PX is the pixel electrode.

In FIG. 29, the one labeled CM is the common electrode.

In at least one embodiment shown in FIG. 24, along the side away from the base substrate, a gate metal layer, a semiconductor layer, a source-drain metal layer, a first ITO layer and a second ITO layer are arranged in order, but not limited.

In at least one embodiment of the present disclosure, the nth output transistor may be arranged in a display area; the display substrate may further include a plurality of rows of gate lines and a plurality of rows of common electrode lines arranged in the display area;
Both the gate line and the common electrode line extend along the second direction;
The nth output transistor is arranged between the gate line and the common electrode line.

As shown in FIG. 30, at least one embodiment of the display substrate may include a first output clock signal line HC1, a first data line DL1, a second output clock signal line HC2, a second data line DL2, a third output clock signal line HC3, a third data line DL3, a fourth output clock signal line HC4, a fourth data line DL4, a fifth output clock signal line HC5, a fifth data line DL5, a sixth output clock signal line HC6, a sixth data line DL6, and the gate line GL extending in the horizontal direction, the driving scan line GS extending in the horizontal direction, and the common electrode line CML extending in the horizontal direction, that are arranged on the base substrate;
The display substrate further includes a first thin film transistor T1, a second thin film transistor T2, a third thin film transistor T3, a fourth thin film transistor T4, a fifth thin film transistor T5 and a sixth thin film transistor T6;
The gate electrode of T1 is electrically connected to the gate line GL, the source electrode of T1 is electrically connected to the first data line DL1, and the drain electrode of T1 is electrically connected to the corresponding pixel electrode;
The gate electrode of T2 is electrically connected to the gate line GL, the source electrode of T2 is electrically connected to the second data line DL2, and the drain electrode of T2 is electrically connected to the corresponding pixel electrode;
The gate electrode of T3 is electrically connected to the gate line GL, the source electrode of T3 is electrically connected to the third data line DL3, and the drain electrode of T3 is electrically connected to the corresponding pixel electrode;
The gate electrode of T4 is electrically connected to the gate line GL, the source electrode of T4 is electrically connected to the fourth data line DL4, and the drain electrode of T4 is electrically connected to the corresponding pixel electrode;
The gate electrode of T5 is electrically connected to the gate line GL, the source electrode of T5 is electrically connected to the fifth data line DL5, and the drain electrode of T5 is electrically connected to the corresponding pixel electrode;
The gate electrode of T6 is electrically connected to the gate line GL, the source electrode of T6 is electrically connected to the sixth data line DL6, and the drain electrode of T6 is electrically connected to the corresponding pixel electrode;
The display substrate further includes a first output transistor MO1, a second output transistor MO2, a third output transistor MO3, a fourth output transistor MO4, a fifth output transistor MO5 and a sixth output transistor MO6;
MO1, MO2, MO3, MO4, MO5 and MO6 are all arranged between the gate line GL and the common electrode line CML;
The gate electrode of MO1 is electrically connected to the driving scan line GS, the source electrode of MO1 is electrically connected to HC1, and the drain electrode of MO1 is electrically connected to the gate line GL;
The gate electrode of MO2 is electrically connected to the driving scan line GS, the source electrode of MO2 is electrically connected to HC2, and the drain electrode of MO2 is electrically connected to the gate line GL;
The gate electrode of MO3 is electrically connected to the driving scan line GS, the source electrode of MO3 is electrically connected to HC3, and the drain electrode of MO3 is electrically connected to the gate line GL;
The gate electrode of MO4 is electrically connected to the driving scan line GS, the source electrode of MO4 is electrically connected to HC4, and the drain electrode of MO4 is electrically connected to the gate line GL;
The gate electrode of MO5 is electrically connected to the driving scan line GS, the source electrode of MO5 is electrically connected to HC5, and the drain electrode of MO5 is electrically connected to the gate line GL;
The gate electrode of MO6 is electrically connected to the driving scan line GS, the source electrode of MO6 is electrically connected to HC6, and the drain electrode of MO6 is electrically connected to the gate line GL.

In at least one embodiment of the display substrate shown in FIG. 30, MO1, MO2, MO3, MO4, MO5 and MO6 are all arranged between the gate line GL and the common electrode line CML.

In at least one embodiment shown in FIG. 30, each data line and each output clock signal line may be formed on the source-drain metal layer, and the gate line GL, the driving scan line GS, and the common electrode line CML may be formed on the gate metal layer.

Optionally, the active layer pattern of at least one transistor included in the driving circuit may include at least two active pattern portions extending along the first direction;
The distance in the second direction between two adjacent active pattern portions in the first direction is greater than the second predetermined distance.

For example, the second predetermined distance may be 3 μm, but is not limited thereto.

In at least one embodiment of the present disclosure, the active layer pattern of the transistor in the driving circuit may be a strip-shaped active layer pattern extending in the vertical direction to facilitate the realization of a narrow border. When there is no requirement for narrow borders, the active layer pattern of the transistor may include at least two active pattern portions extending in the vertical direction, and the distance between every two adjacent active pattern portions in the horizontal direction is greater than or equal to 3 μm, to facilitate heat dissipation and improve the performance of the transistor.

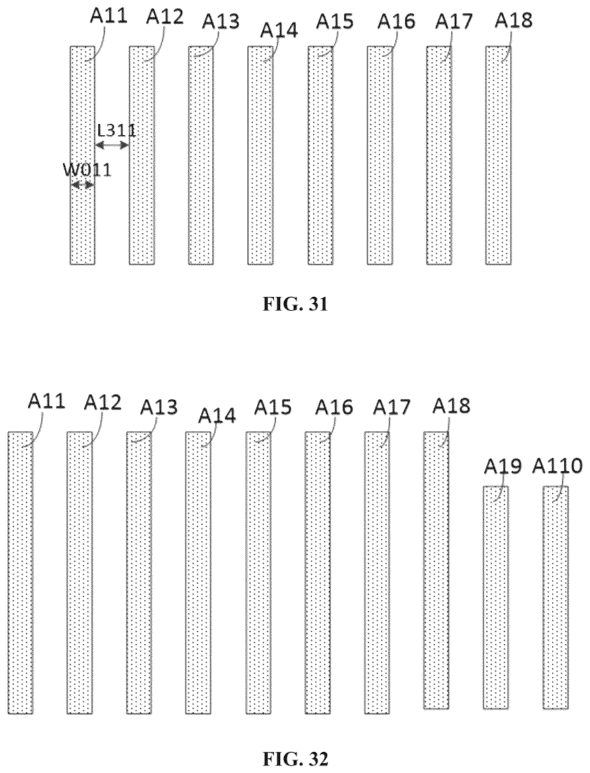

As shown in FIG. 31, the active layer pattern of at least one transistor in the driving circuit may include a first active pattern portion A11, a second active pattern portion A12, a third active pattern portion A13, a fourth active pattern portion A14, a fifth active pattern portion A15, a sixth active pattern portion A16, a seventh active pattern portion A17 and an eighth active pattern portion A18 that are independent of each other;
All, A12, A13, A14, A15, A16, A17 and A18 extend in the vertical direction;
The width W011 of A11 along the horizontal direction is 5 μm;
All and A12 are adjacent, and the distance L311 in the horizontal direction between A11 and A12 is 7 μm;
The width of A12 along the horizontal direction, the width of A13 along the horizontal direction, the width of A14 along the horizontal direction, the width of A15 along the horizontal direction, the width of A16 along the horizontal direction, the width of A17 along the horizontal direction and the width of A17 along the horizontal direction are all 5 μm;
The distance in the horizontal direction between two adjacent active pattern parts is 7 μm;
But it is not limited to this.

In at least one embodiment shown in FIG. 31, the lengths of active pattern portions along the vertical direction are consistent, but are not limited to this. In actual operation, the lengths of the active pattern portions along the vertical direction may be inconsistent or not completely consistent.

As shown in FIG. 32, the active layer pattern of at least one transistor in the driving circuit may include a first active pattern portion A11, a second active pattern portion A12, a third active pattern portion A13, a fourth active pattern portion A14, a fifth active pattern portion A15, a sixth active pattern portion A16, a seventh active pattern portion A17, an eighth active pattern portion A18, a ninth active pattern portion A19 and a tenth active pattern portion A110 that are independent of each other;
All, A12, A13, A14, A15, A16, A17, A18, A19 and A110 extend in the vertical direction;
The width of A11 along the horizontal direction, the width of A12 along the horizontal direction, the width of A13 along the horizontal direction, the width of A14 along the horizontal direction, the width of A15 along the horizontal direction, the width of A16 along the horizontal direction, the width of A17 along the horizontal direction, the width of A18 along the horizontal direction, the width of A19 along the horizontal direction and the width of A110 along the horizontal direction are all 5 μm;
The distance in the horizontal direction between two adjacent active pattern portions is 7 μm;
The length of A11 along the vertical direction, the length of A12 along the vertical direction, the length of A13 along the vertical direction, the length of A14 along the vertical direction, the length of A15 along the vertical direction, the length of A16 along the vertical direction, the length of A17 along the vertical direction, the length of A18 in the vertical direction are all consistent; the length of A19 in the vertical direction is less than the length of A11 in the vertical direction, and the length of A110 in the vertical direction is less than the length of A11 in the vertical direction. In specific implementation, after forming the driving circuit and pixel circuit on the base substrate, a frame sealant needs to be applied. The frame sealant may cover transistors in the driving circuit other than M15, M18, each output transistor, each output pull-down transistor and each on-off control transistor.

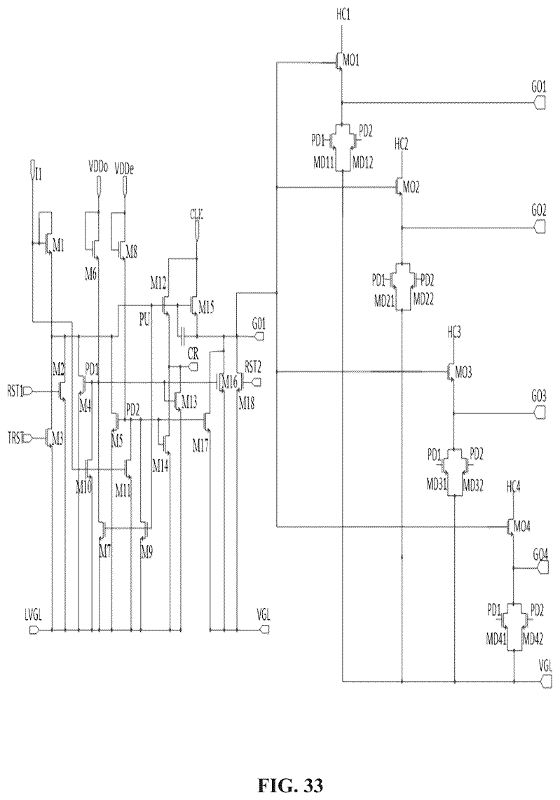

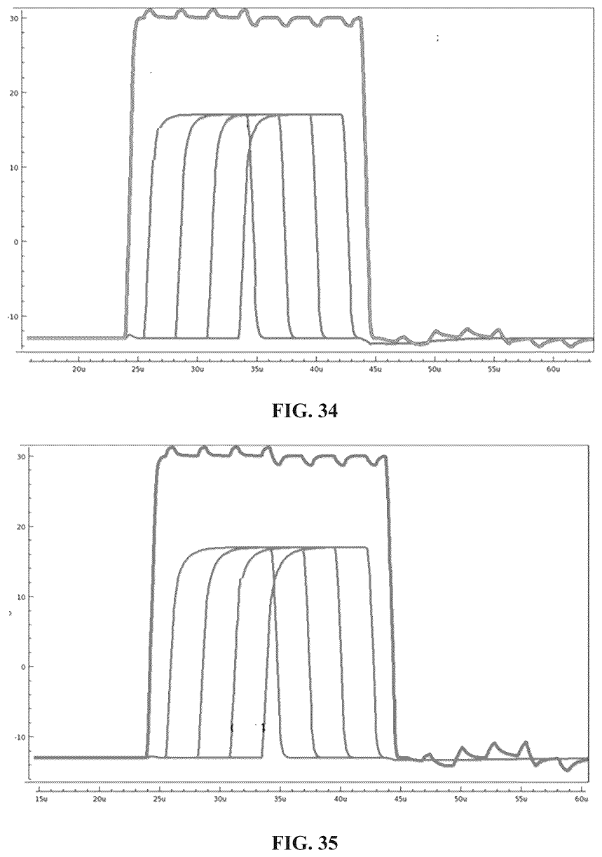

The difference between the driving circuit shown in FIG. 33 of at least one embodiment of the present disclosure and the driving circuit shown in FIG. 8 of at least one embodiment of the present disclosure is that the driving signal generation circuit shown in FIG. 33 of at least one embodiment of the present disclosure remove MV1, MV2, MV3, MV4, CO1, CO2, CO3 and CO4;
After removing each on-off transistor and each output capacitor, the gate voltage of each output transistor no longer has a bootstrap effect. In order to ensure that each driving signal output terminal has a normal waveform output, the high voltage value of the output clock signal provided by each output clock signal line is set to 17V, and the high voltage value of each driving control clock signal can be set to 30V. By increasing the gate-source voltage of each output transistor, the charging of each driving signal output terminal is ensured.

As shown in FIGS. 34 and 35, the driving circuit shown in FIG. 33 of at least one embodiment of the present disclosure can operate normally after the reliability test.

FIG. 34 is a timing diagram of the driving circuit shown in FIG. 33 of at least one embodiment of the present disclosure in an initial state without going through a reliability test.

FIG. 35 is a timing diagram of the driving circuit shown in FIG. 33 of at least one embodiment of the present disclosure after passing a reliability test (reliability test for 1000 hours at 60 degrees Celsius).

When at least one embodiment of the driving circuit shown in FIG. 33 of the present disclosure is used and the driving circuits are arranged in the peripheral area, the width of the frame occupied by the driving circuit can be reduced by 0.3 mm compared to the width of the frame occupied by the existing driving circuit, which helps achieve narrow bezels.

When using the driving circuit shown in FIG. 33 of at least one embodiment of the present disclosure, and arranging the driving control signal generation circuit in the peripheral area, and arranging each output transistor and each output clock signal generation circuit in the display area, the width of the frame occupied by the driving circuit can be reduced by 0.5 mm compared to the width of the frame occupied by the existing driving circuit, which is conducive to achieving a narrow frame.

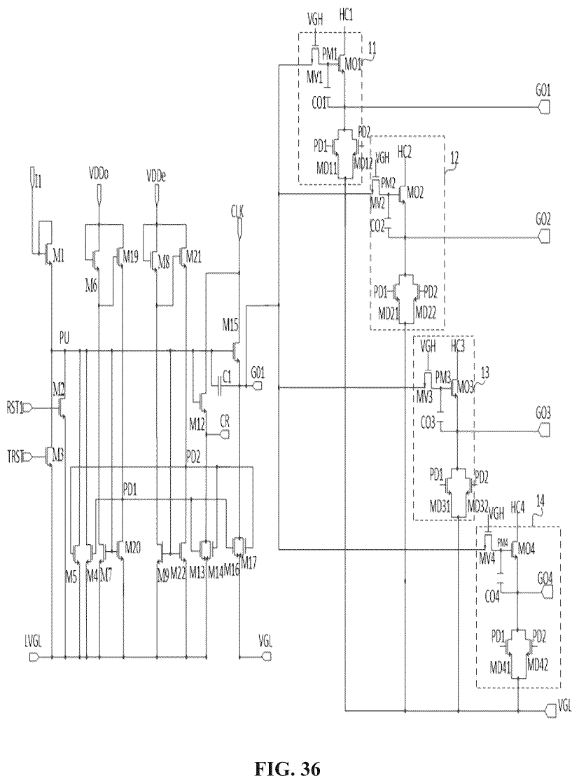

The difference between the driving circuit shown in FIG. 36 of at least one embodiment of the present disclosure and the driving circuit shown in FIG. 8 of at least one embodiment of the present disclosure is that: the driving control signal generation circuit does not include M10, M11 and M18;
The driving control signal generation circuit also includes a nineteenth transistor M19, a twentieth transistor M20, a twenty-first transistor M21, and a twenty-second transistor M22;
The gate electrode of M7 is electrically connected to the pull-up node PU, the drain electrode of M7 is electrically connected to the source electrode of M6, and the source electrode of M7 is electrically connected to the second low voltage line LVGL;
The gate electrode of M19 is electrically connected to the drain electrode of M7, the drain electrode of M19 is electrically connected to the first control voltage line VDDo, and the source electrode of M19 is electrically connected to the first pull-down node PD1;
The gate electrode of M20 is electrically connected to the pull-up node PU, the drain electrode of M20 is electrically connected to the first pull-down node PD1, and the source electrode of M20 is electrically connected to the second low-voltage line LVGL;
The gate electrode of M9 is electrically connected to the pull-up node PU, the drain electrode of M9 is electrically connected to the source electrode of M8, and the source electrode of M9 is connected to the second low voltage line LVGL;
The gate electrode of M21 is electrically connected to the drain electrode of M9, the drain electrode of M21 is electrically connected to the second control voltage line VDDe, and the source electrode of M21 is electrically connected to the second pull-down node PD2;
The gate electrode of M22 is electrically connected to the pull-up node PU, the drain electrode of M22 is electrically connected to the second pull-down node PD2, and the source electrode of M22 is electrically connected to the second low voltage line LVGL.

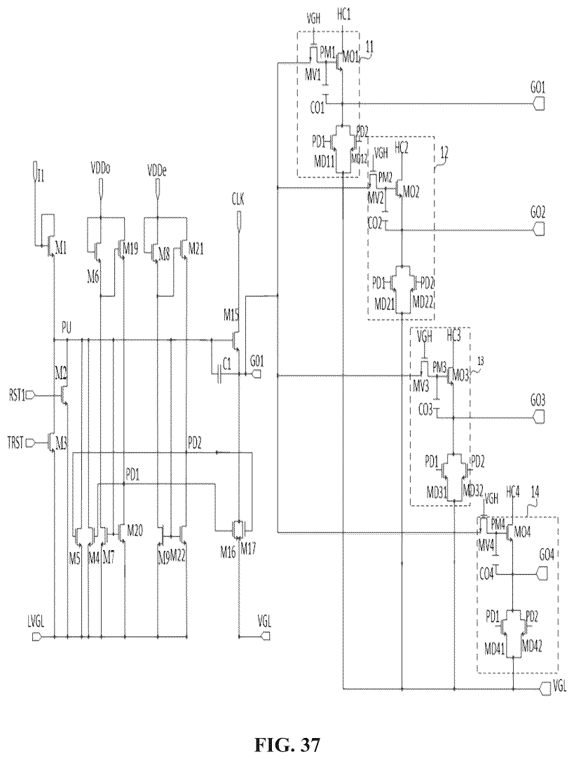

The difference between the driving circuit shown in FIG. 37 of at least one embodiment of the present disclosure and the driving circuit shown in FIG. 36 of at least one embodiment of the present disclosure is that the twelfth transistor M12, the thirteenth transistor M13 and the fourteenth transistor M14 are not provided.

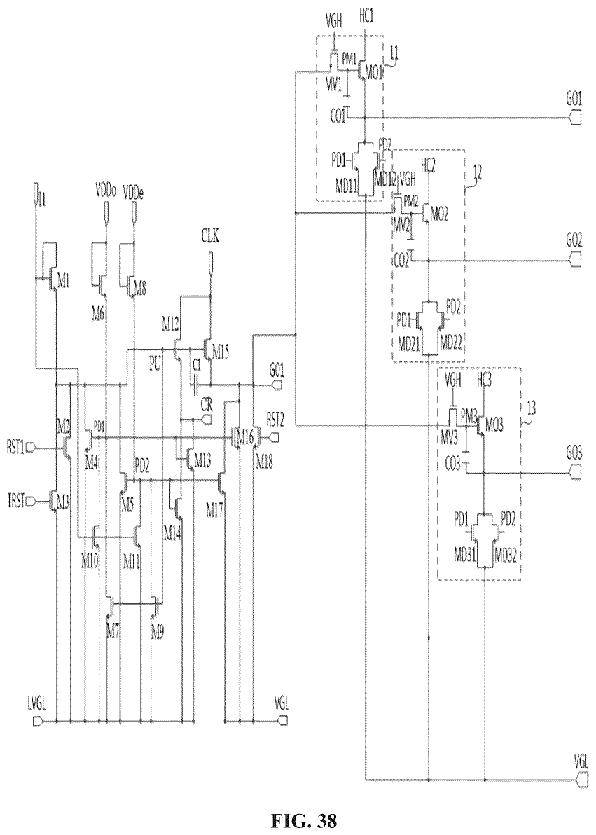

The difference between the driving circuit shown in FIG. 38 of at least one embodiment of the present disclosure and the driving circuit shown in FIG. 8 of at least one embodiment of the present disclosure is that the fourth output sub-circuit 14 is not provided.

In the driving circuit shown in FIG. 38 of at least one embodiment of the present disclosure, the three stages of output sub-circuits output three stages of driving signals respectively under the control of the driving control signal, which can realize one driving circuit driving a plurality of rows of gate lines, which effectively reduces the number of transistors used in the driving circuit and facilitates the realization of narrow borders.

In at least one embodiment of the present disclosure, the process condition used is an oxide process with a mobility of 10, but it is not limited to this. In actual operation, an oxidation process with a mobility of 20 or 30 can also be used. But it is not limited to this.

The above descriptions are implementations of the present disclosure. It should be pointed out that those skilled in the art can make some improvements and modifications without departing from the principle of the present disclosure. These improvements and modifications shall also fall within the scope of the present disclosure.

1. A driving circuit, comprising a driving control signal generation circuit and a multi-channel output circuit; wherein the multi-channel output circuit includes N stage of output sub-circuits; N is an integer greater than 1;
the driving control signal generation circuit is configured to generate a driving control signal, and the driving control signal is output through a driving control signal output terminal;
an nth output sub-circuit is electrically connected to the driving control signal output terminal, an nth output clock signal line and an nth driving signal output terminal respectively, the nth output sub-circuit is configured to control the nth output clock signal line to provide an nth output clock signal to the nth driving signal output terminal under the control of the driving control signal; n is a positive integer less than or equal to N.

2. The driving circuit according to claim 1, wherein the nth output sub-circuit includes an nth output transistor;
a control electrode of the nth output transistor is electrically connected to the driving control signal output terminal, a first electrode of the nth output transistor is electrically connected to the nth output clock signal line, and a second electrode of the nth output transistor is electrically connected to the nth driving signal output terminal.

3. The driving circuit according to claim 2, wherein the nth output sub-circuit further includes an nth on-off control transistor; the control electrode of the nth output transistor is electrically connected to the driving control signal output terminal through the nth on-off control transistor;
a control electrode of the nth on-off control transistor is electrically connected to a first voltage line, a first electrode of the nth on-off control transistor is electrically connected to the driving control signal output terminal, and a second electrode of the nth on-off control transistor is electrically connected to the control electrode of the nth output transistor.

4. The driving circuit according to claim 3, wherein the nth output sub-circuit further includes an nth output capacitor;
a first electrode plate of the nth output capacitor is electrically connected to the control electrode of the nth output transistor, and a second electrode plate of the nth output capacitor is electrically connected to the second electrode of the nth output transistor.

5. The driving circuit according to claim 2, wherein the nth output sub-circuit further includes an nth output pull-down unit;
the nth output pull-down unit is electrically connected to a pull-down node, the nth driving signal output terminal and a second voltage line respectively, and is configured to control to connect the nth driving signal output terminal and the second voltage line under the control of a potential of the pull-down node,
wherein the pull-down node includes a first pull-down node and a second pull-down node; the nth output pull-down unit includes an nth first output pull-down transistor and an nth second output pull-down transistor;
a control electrode of the nth first output pull-down transistor is electrically connected to the first pull-down node, and a first electrode of the nth first output pull-down transistor is electrically connected to the nth driving signal output terminal, a second electrode of the nth first output pull-down transistor is electrically connected to the second voltage line;
a control electrode of the nth second output pull-down transistor is electrically connected to the second pull-down node, and a first electrode of the nth second output pull-down transistor is electrically connected to the nth driving signal output terminal, a second electrode of the nth second output pull-down transistor is electrically connected to the second voltage line.

6. (canceled)

7. The driving circuit according to claim 1, wherein the driving control signal generation circuit includes a pull-up node control circuit, a first pull-down node control circuit, a second pull-down node control circuit and a driving control output circuit;
the pull-up node control circuit is configured to control a potential of the pull-up node;
the first pull-down node control circuit is configured to control a potential of the first pull-down node under the control of the potential of the pull-up node;
the second pull-down node control circuit is configured to control a potential of the second pull-down node under the control of the potential of the pull-up node;
the driving control output circuit is electrically connected to the pull-up node, the first pull-down node, the second pull-down node, the driving control signal output terminal, the driving control clock signal line and the second voltage line, respectively, is configured to control to connect the driving control clock signal line and the driving control signal output terminal under the control of the potential of the pull-up node, and control to connect the driving control signal output terminal and the second voltage line under the control of the potential of the first pull-down node, and control to connect the driving control signal output terminal and the second voltage line under the control of the potential of the second pull-down node.

8. The driving circuit according to claim 7, wherein the driving control signal generation circuit further includes a carry output circuit;
the carry output circuit is electrically connected to the pull-up node, the first pull-down node, the second pull-down node, a carry output terminal, the driving control clock signal line and a third voltage line respectively, and is configured to control to connect the driving control clock signal line and the carry output terminal under the control of the potential of the pull-up node, and control to connect the carry output terminal and the third voltage line under the control of the potential of the first pull-down node, and control to connect the carry output terminal and the third voltage line under the control of the potential of the second pull-down node.

9. The driving circuit according to claim 8, wherein the pull-up node control circuit is electrically connected to an input terminal, a frame reset line, the first pull-down node, the second pull-down node, a first reset terminal, the pull-up node and the third voltage line respectively, is configured to control the potential of the pull-up node under the control of an input signal provided by the input terminal, and control to connect the pull-up node and the third voltage line under the control of a frame reset signal provided by the frame reset line, control to connect the pull-up node and the third voltage line under the control of the potential of the first pull-down node, and control to connect the pull-up node and the third voltage line under the control of the potential of the second pull-down node, and control to connect the pull-up node and the third voltage line under the control of a first reset signal provided by the first reset terminal;
the first pull-down node control circuit is electrically connected to a first control voltage line, the first pull-down node, the pull-up node and the third voltage line respectively, and is configured to control the potential of the first pull-down node under the control of a first control voltage provided by the first control voltage line and the potential of the pull-up node;
the second pull-down node control circuit is electrically connected to a second control voltage line, the second pull-down node, the pull-up node and the third voltage line respectively, and is configured to control the potential of the second pull-down node under the control of a second control voltage provided by the second control voltage line and the potential of the pull-up node;
the driving control output circuit is also electrically connected to a second reset terminal, and is configured to control to connect the driving control signal output terminal and the second voltage line under the control of a second reset signal provided by the second reset terminal.

10. The driving circuit according to claim 9, wherein the pull-up node control circuit includes a first transistor, a second transistor, a third transistor, a fourth transistor and a fifth transistor;
a control electrode of the first transistor is electrically connected to a first electrode of the first transistor and the input terminal, and a second electrode of the first transistor is electrically connected to the pull-up node;
a control electrode of the second transistor is electrically connected to the first reset terminal, a first electrode of the second transistor is electrically connected to the pull-up node, and a second electrode of the second transistor is electrically connected to the third voltage line;
a control electrode of the third transistor is electrically connected to the frame reset terminal, a first electrode of the third transistor is electrically connected to the pull-up node, and a second electrode of the third transistor is electrically connected to the third voltage line;
a control electrode of the fourth transistor is electrically connected to the first pull-down node, a first electrode of the fourth transistor is electrically connected to the pull-up node, and a second electrode of the fourth transistor is electrically connected to the third voltage line;
a control electrode of the fifth transistor is electrically connected to the second pull-down node, a first electrode of the fifth transistor is electrically connected to the pull-up node, and a second electrode of the fifth transistor is electrically connected to the third voltage line;
the first pull-down node control circuit includes a sixth transistor and a seventh transistor;
a control electrode of the sixth transistor and a first electrode of the sixth transistor are electrically connected to the first control voltage line, and a second electrode of the sixth transistor is electrically connected to the first pull-down node;
a control electrode of the seventh transistor is electrically connected to the pull-up node, a first electrode of the seventh transistor is electrically connected to the first pull-down node, and a second electrode of the seventh transistor is electrically connected to the third voltage line;
the second pull-down node control circuit includes an eighth transistor and a ninth transistor;
a control electrode of the eighth transistor and a first electrode of the eighth transistor are electrically connected to the second control voltage line, and a second electrode of the eighth transistor is electrically connected to the second pull-down node;
a control electrode of the ninth transistor is electrically connected to the pull-up node, a first electrode of the ninth transistor is electrically connected to the second pull-down node, and a second electrode of the ninth transistor is electrically connected to the third voltage line.

11. The driving circuit according to claim 10, wherein a ratio between a channel width to length ratio of the seventh transistor and a channel width to length ratio of the sixth transistor is greater than or equal to 6, and a ratio between a channel width to length of the ninth transistor and a channel width to length ratio of the eighth transistor is greater than or equal to 6;
or
wherein the first pull-down node control circuit further includes a tenth transistor, and the second pull-down node control circuit further includes an eleventh transistor;
a control electrode of the tenth transistor is electrically connected to the input terminal, a first electrode of the tenth transistor is electrically connected to the first pull-down node, and a second electrode of the tenth transistor is electrically connected to the third voltage line;
a control electrode of the eleventh transistor is electrically connected to the input terminal, a first electrode of the eleventh transistor is electrically connected to the second pull-down node, and a second electrode of the eleventh transistor is electrically connected to the third voltage line;
or
wherein the carry output circuit includes a twelfth transistor, a thirteenth transistor and a fourteenth transistor;
a control electrode of the twelfth transistor is electrically connected to the pull-up node, a first electrode of the twelfth transistor is electrically connected to the driving control clock signal line, and a second electrode of the twelfth transistor is electrically connected to the carry output terminal;
a control electrode of the thirteenth transistor is electrically connected to the first pull-down node, a first electrode of the thirteenth transistor is electrically connected to the carry output terminal, and a second electrode of the thirteenth transistor is electrically connected to the third voltage line;
a control electrode of the fourteenth transistor is electrically connected to the second pull-down node, a first electrode of the fourteenth transistor is electrically connected to the carry output terminal, and a second electrode of the fourteenth transistor is electrically connected to the third voltage line;
the driving control output circuit includes a fifteenth transistor, a sixteenth transistor, a seventeenth transistor, an eighteenth transistor and a first capacitor;
a control electrode of the fifteenth transistor is electrically connected to the pull-up node, a first electrode of the fifteenth transistor is electrically connected to the driving control clock signal line, and a second electrode of the fifteenth transistor is electrically connected to the driving control signal output terminal;
a control electrode of the sixteenth transistor is electrically connected to the first pull-down node, a first electrode of the sixteenth transistor is electrically connected to the driving control signal output terminal, and a second electrode of the sixteenth transistor is electrically connected to the second voltage line;
a control electrode of the seventeenth transistor is electrically connected to the second pull-down node, a first electrode of the seventeenth transistor is electrically connected to the driving control signal output terminal, and a second electrode of the seventeenth transistor is electrically connected to the second voltage line;
a control electrode of the eighteenth transistor is electrically connected to the second reset terminal, a first electrode of the eighteenth transistor is electrically connected to the driving control signal output terminal, and a second electrode of the eighteenth transistor is electrically connected to the second voltage line;
a first electrode plate of the first capacitor is electrically connected to the pull-up node, and a second electrode plate of the first capacitor is electrically connected to the driving control signal output terminal.

12. (canceled)

13. (canceled)

14. A display substrate, comprising a base substrate and a plurality of stages driving circuits according to claim 1 arranged on the base substrate.

15. The display substrate according to claim 14, wherein the display substrate includes a peripheral area and a display area; the driving circuit includes a driving control signal generation circuit and a multi-channel output circuit;
the multi-channel output circuit and the driving control signal generation circuit are arranged in the peripheral area;
the multi-channel output circuit is arranged on a side of the driving control signal generation circuit close to the display area.

16. The display substrate according to claim 15, wherein the multi-channel output circuits include N output sub-circuits and N output clock signal lines; N is an integer greater than 1;
the output clock signal line is arranged on a side of the output sub-circuit close to the display area, and the output clock signal line extends along a first direction.

17. The display substrate according to claim 16, wherein the nth output sub-circuit includes an nth output transistor, and the nth output transistor is arranged between the driving control signal generation circuit and the display area; n is a positive integer less than or equal to N.

18. The display substrate according to claim 16, wherein the nth output sub-circuit includes an nth output transistor; n is a positive integer less than or equal to N;
an active layer pattern of the nth output transistor includes at least one mutually independent active portion; the active portion extends along the first direction.

19. The display substrate according to claim 18, wherein
active layer patterns of output transistors respectively included in the N output sub-circuits are arranged along the first direction;
or
wherein the nth output sub-circuit further includes an nth output pull-down unit, and the nth output pull-down unit includes an nth first output pull-down transistor and an nth second output pull-down transistor;
an active layer pattern of the nth first output pull-down transistor and an active layer pattern of the nth second output pull-down transistor are arranged along the first direction;
the active layer pattern of the nth first output pull-down transistor and the active layer pattern of the nth second output pull-down transistor both extend along the first direction,
wherein the output pull-down units respectively included in the N output sub-circuits are arranged along the first direction.

20. (canceled)

21. (canceled)

22. The display substrate according to claim 14, wherein the display substrate includes a peripheral area and a display area; the driving circuit includes a driving control signal generation circuit and a multi-channel output circuit;
the driving control signal generation circuit is arranged in the peripheral area;
the multi-channel output circuit includes N output sub-circuits, and the nth output sub-circuit includes an nth output transistor; N is an integer greater than 1, and n is a positive integer less than or equal to N;
the nth output transistor is arranged in the display area,
wherein the display substrate further includes a plurality of gate lines and a plurality of common electrode lines arranged in the display area;
the gate line and the common electrode line extend along a second direction;
the nth output transistor is arranged between the gate line and the common electrode line;
or
wherein the multi-channel output circuit further includes N output clock signal lines;
the output clock signal lines are arranged in the display area.

23. (canceled)

24. (canceled)

25. The display substrate according to claim 14, wherein the driving circuit includes a driving control signal generation circuit; the driving control signal generation circuit includes a first transistor, a fourth transistor, a fifth transistor, a tenth transistor, a twelve transistor and a fifteenth transistor;
a length to width ratio of an active layer pattern of the first transistor is greater than or equal to 80 and less than or equal to 130;
a length to width ratio of an active layer pattern of the fourth transistor and a length to width ratio of an active layer pattern of the fifth transistor are greater than and equal to 18 and less than or equal to 32;
a length to width ratio of an active layer pattern of the tenth transistor is greater than or equal to 5 and less than or equal to 10;
a length to width ratio of an active layer pattern of the twelfth transistor is greater than or equal to 25 and less than or equal to 50;
a length to width ratio of an active layer pattern of the fifteenth transistor is greater than or equal to 16 and less than or equal to 40;
the length to width ratio is a ratio between the length of the active layer pattern along the first direction and the width of the active layer pattern along the second direction;
or
wherein the driving circuit includes a driving control signal generating circuit; the driving control signal generating circuit includes a first capacitor;
an electrode plate of the first capacitor includes a first electrode plate portion and a second electrode plate portion that are connected to each other; the first electrode plate portion is in the shape of a block;
the second electrode plate portion extends along the first direction;
a ratio of the length of the second electrode plate portion along the first direction to the width of the second electrode plate portion along the second direction is greater than or equal to 6 and less than or equal to 25;
or
wherein the driving circuit includes a driving control signal generation circuit and a multi-channel output circuit; the driving control signal generation circuit includes a first capacitor and a fifteenth transistor; the multi-channel output circuit includes an output sub-circuit; the output sub-circuit includes an on-off control transistor;
the first capacitor is arranged between the fifteenth transistor and the on-off control transistor.

26. (canceled)

27. (canceled)

28. The display substrate according to claim 18, wherein the nth output sub-circuit further includes an nth on-off control transistor and an nth output capacitor; the nth on-off control transistor and the nth output capacitor are both arranged in the peripheral area;
an active layer pattern of the nth on-off control transistor extends along the first direction;
active layer patterns of on-off control transistors respectively included in the N output sub-circuits are arranged along the first direction;
output capacitors respectively included in the N output sub-circuits are arranged along the first direction.

29. The display substrate according to claim 14, wherein the display substrate includes a plurality of signal lines, and the signal lines are electrically connected to the driving control signal generation circuit included in the driving circuit, the signal line extends along the first direction;
a shortest distance along the second direction between a gate electrode of a transistor included in the driving control signal generation circuit and a signal line closest to the transistor in the driving control signal generation circuit is greater than a first predetermined distance;
the first direction intersects the second direction;
the gate electrode of the transistor and the signal line are located on a same layer.

30. (canceled)

31. (canceled)
